(19) United States
(12) Patent Application Publication
(10) Pub. No.: US 2018/0278029 A9
(43) Pub. Date: Sep. 27, 2018

(54) SYSTEM AND METHOD FOR DISTRIBUTION OF ELECTRICAL POWER

(71) Applicant: Lawrence A. Ellis, Wakefield, MA (US)

(72) Inventor: Lawrence A. Ellis, Wakefield, MA (US)

(21) Appl. No.: 15/090,972

(22) Filed: Apr. 5, 2016

Related U.S. Application Data
(63) Continuation of application No. 12/567,021, filed on Sep. 25, 2009, now abandoned.
Application No. 12/567,021 is a continuation of application No. 12/567,063, filed on Sep. 25, 2009.
(60) Provisional application No. 61/144,663, filed on Jan. 14, 2009.
(60) Provisional application No. 61/144,663, filed on Jan. 14, 2009.

(51) Int. Cl. H02B 1/01; H02B 1/20; F21S 8/00; F21V 21/02

(52) U.S. Cl. CPC H02B 1/012; F21V 21/02; F21S 8/033; H02B 1/20

(57) ABSTRACT

A method of mounting an electrically powered device having power receiving contacts and a ground contact on a display comprising a mounting wall comprising:
mounting one or more power delivery members on the rear surface of the mounting wall;
housing the power receiving and ground contact of an electrically powered device in a housing that prevents electrically conductive manual engagement or contact,
inserting the housed power receiving and ground contacts of the electrically powered device through one of the series of apertures in the mounting wall to power and mount the device.

### RELATED APPLICATIONS

This is a continuation of and claims the benefit of priority to U.S. application Ser. No. 12/567,021 filed Sep. 25, 2009, the disclosure of which is incorporated in its entirety by reference as if fully set forth herein. This is also a continuation of and claims the benefit of priority to U.S. application Ser. No. 12/567,063 filed Sep. 25, 2009, the disclosure of which is incorporated in its entirety by reference as if fully set forth herein.

### FIELD OF THE INVENTION

The present invention relates to electrical power distribution and mounting systems and more particularly to a modular system for mounting and displaying electrically powered devices, where the mounting system provides for the distribution of power.

### BACKGROUND OF THE INVENTION

Display systems for electrically powered devices such as lamps, lights, consumer electronics, bulbs and electrically powered devices generally within a retail store environment normally requires a racking, gondola, shelving, cabinetry, frame, bin, wall, furniture or other support system that must be manufactured to fit a selected space and a selected number of different electrically powered devices on a custom or individual basis. Wiring, circuitry and power supply devices for connection to the electrically powered devices are typically installed on and throughout the support system on a custom hand-made or individual basis. The task of connecting a master or original source of power to the multitude of individual electrically powered devices that are typically mounted on a retail display system remains a labor intensive task of routing and connecting individual wires or collections of wires for each separate device along extensive distances that are disposed along overhead, underground or floor level locations.

### SUMMARY OF THE INVENTION

In accordance with the invention there is provided an electrical power distribution and mounting system, the system comprising:

a housing comprising a mounting wall having a front side, a rear side and a plurality of apertures arranged in a select pattern;

a power delivery member mounted on the rear side of the mounting wall, the power delivery member including power delivery contacts and a ground contact aligned with the plurality of apertures on the rear side of the mounting wall and arranged on the power delivery member in a select arrangement for electrically powering one or more electrically powered devices;

each electrically powered device including complementary mating contacts projecting from the electrically powered device in an arrangement that is complementary to the select arrangement of the power delivery and ground contacts of the power delivery member;

each electrically powered device being mountable in a stable position on the front side of the mounting wall such that the mating contacts projecting from the electrically powered device extend through one of the apertures in the mounting wall and engage with a corresponding power delivery contact and ground contact of the power delivery member when or as the electrically powered device is fully mounted in the stable position; and,

wherein the select arrangement of the power delivery contacts and the ground contact of the electrical power delivery member is selected such that the ground contact of the power delivery member engages with a complementary mating contact of the electrically powered device before the power delivery contacts of the power delivery member engage with a complementary mating contact of the electrically powered device during the course of the electrically powered device being mounted on the front side of the mounting wall.

The power delivery members are typically mounted on the rear side of the mounting wall and the power delivery contacts and the ground contact are all arranged such that manual engagement with the power delivery contacts through an aperture from a position from the front side of the mounting wall is prevented. The electrically powered devices typically have a base having two or more mounting pins protruding from the base in a pattern complementary to the select pattern of the apertures in the mounting wall.

The mounting pins preferably protrude from the base of the electrically powered devices such that the two or more mounting pins of the base are simultaneously insertable through two apertures from the front side of the mounting wall;

the mounting pins and the apertures being adapted for retention of the received mounting pins against lateral or axial movement of the pins out of the apertures;

the mating contacts being arranged on the electrically powered device and the electrical power delivery contacts being arranged on the rear side of the mounting wall for electrically conductive engagement between the matting contacts and the power delivery and ground contacts during the course of insertion of the mounting pins through the two apertures. At least one of the mounting pins preferably comprises a shaft and a head connected to the end of the shaft, the shaft and the head having selected configurations, the apertures in the mounting wall having a first portion complementary to the head configuration for receiving the head and a second portion complementary to the shaft configuration for receiving the shaft; and, the head of the at least one pin forming an interference fit against the second portion of the primary aperture to mount the base of the electrically powered device on the mounting wall.

In a preferred embodiment, one of the electrically powered device and the mounting wall have a primary pin;

the other of the electrically powered device and the mounting wall having a primary aperture that is adapted to receive and retain the primary pin against lateral or axial movement out of the primary aperture; and,

wherein the complementary mating contacts and the power delivery contacts are are routed or guided into engagement upon receipt of the primary pin within the primary aperture.

In such an embodiment, the primary aperture is adapted to receive and retain the primary pin against lateral or axial movement out of the primary aperture, the primary pin being adapted to cooperate with the primary aperture against lateral or axial movement of the primary pin out of the primary aperture once received.

Typically, the primary pin comprises a shaft and a head connected to the end of the shaft, the shaft and the head having selected configurations, the primary aperture having a first portion complementary to the head configuration for receiving the head and a second portion complementary to the shaft configuration for receiving the shaft; and,

the head of the primary pin forming an interference fit against the second portion of the primary aperture to mount the support member of the electrically powered device on the wall.

In such an embodiment, the electrically powered device preferably comprises an electrically powered fixture mounted to a support member;

the primary pin being rigidly connected to the support member and the primary aperture is formed in the wall of the housing; and,

the primary aperture, the pin and the power delivery member being arranged relative to each other so that the complementary mating contacts are routed into engagement with the power delivery and ground contacts upon receipt of the primary pin within the primary aperture.

Most preferably, the primary pin is rigidly connected to the electrically powered device and the primary aperture is formed within the mounting wall, the primary pin housing the complementary mating contacts of the electrically powered device, the complementary mating contacts being received through the primary aperture together with receipt of the primary pin through the primary aperture.

Preferably one of the electrically powered device and the mounting wall have a second pin;

the other of the electrically powered device and the mounting wall having a second aperture that receives the second pin; and,

the primary and second pins and the primary and second apertures being arranged such that the complementary mating contacts and the power delivery and ground contacts are guided into engagement with each other upon receipt of the primary and second pins within their corresponding primary and second apertures.

In such an embodiment, the pins are preferably attached to the electrically powered device and the apertures are disposed in the wall of the housing.

The plurality of apertures disposed within the mounting wall are preferably arranged such that the primary and second pins of the electrically powered device are receivable within a plurality of different pairs of the plurality of apertures, additional power delivery members being mounted on the rear side of the mounting wall in an arrangement to enable engagement of the mating contacts with power delivery contacts via each one of the plurality of apertures.

The electrically powered devices typically have a third pin, the complementary mating contacts being housed within the third pin, the third pin being receivable through a complementary aperture formed in the wall of the housing, the primary, second and complementary apertures being arranged on the wall and the primary, second and third pins being arranged on the support member such that the pins are all receivable within the apertures to route or guide the complementary mating contacts into engagement with the power delivery contacts upon receipt of the pins within the apertures.

The mounting wall typically has a plurality of apertures disposed within the mounting wall in an arrangement such that the primary and second and complementary pins of the electrically powered device are receivable within a plurality of different sets of three of the plurality of apertures.

In such an embodiment, at least two of the pins and the respective apertures in which the at least two pins are received are adapted to receive and retain the at least two pins against lateral or axial movement out of the respective apertures.

The system preferably includes at least two power delivery members arranged on the rear side of the mounting wall such that at least two electrically powered devices are independently mountable in a stable position on the front side of the mounting where the complementary mating contacts of the two electrically powered devices are all engaged with a corresponding power delivery and ground contact of the two respective power delivery members when each of the at least two electrically powered devices are fully mounted in the stable position on the front side of the mounting wall.

In such an embodiment, each of the power delivery contacts of each of the power delivery members is typically connected to a common source of electrical power.

Most preferably, the complementary mating contacts of the electrically powered device include a spring mechanism that maintains the mating contacts in engagement with the power delivery and ground contact.

Typically, the mounting wall comprises a thin sheet of rigid material having a height and a width and one or more struts disposed at one more vertically spaced positions along the height, the struts being attached to multiple positions extending across the width of the sheet.

In another aspect of the invention there is provided a method of mounting an electrically powered device having power receiving contacts and a ground contact for mounting and powering of the electrically powered device on a display housing having a mounting wall having a front surface and a rear surface, the method comprising:

mounting one or more power delivery members having power delivery contacts and a ground contact on the rear surface of the mounting wall in a select arrangement;

forming a series of apertures in the mounting wall that are adapted to receive the power receiving and ground contact of the electrically powered device upon mounting of the electrically powered device on the front surface of the mounting wall;

arranging the power delivery and ground contact of the power delivery members and arranging the power receiving and ground contact of the electrically powered devices in an arrangement such that when the electrically powered devices are mounted on the front surface of the mounting wall, the ground contact of the power delivery member engages with a complementary mating contact of the electrically powered device before the power delivery contacts of the power delivery member engage with a complementary power receiving contact of the electrically powered device during the course of the electrically powered device being mounted on the front side of the mounting wall; and,

mounting the electrically powered device on the front side of the mounting wall.

Such a method typically further comprises providing the electrically powered device with a primary pin in an arrangement that enables the primary pin to be received within a primary mounting aperture in the mounting wall; and,

forming the primary aperture into a configuration that prevents lateral or axial movement of the primary pin out of the primary aperture on receipt of the pin within the primary aperture.

In another aspect of the invention there is provided an electrical power distribution and mounting system, the system comprising:

a housing comprising a mounting wall having a front side, a rear side and a plurality of apertures arranged in a select pattern;

a power delivery member mounted on the rear side of the mounting wall, the power delivery member including power delivery contacts and a ground contact aligned with the plurality of apertures in the mounting wall and arranged on the power delivery member in a select arrangement;

one or more electrically powered devices including complementary mating contacts projecting from the electrically powered device in an arrangement that is complementary to the select arrangement of the power delivery and ground contacts of the power delivery member;

each electrically powered device being mountable in a stable position on the front side of the mounting wall such that the mating contacts projecting from the electrically powered device extend through an aperture in the mounting wall and engage with a corresponding power delivery contact and ground contact of the power delivery member when the electrically powered device is fully mounted in the stable position; and,

wherein one of the electrically powered device and the mounting wall have a primary pin;

the other of the electrically powered device and the mounting wall having a primary aperture that is adapted to receive and retain the primary pin against lateral or axial movement out of the primary aperture; and,

wherein the complementary mating contacts and the power delivery contacts and ground contact are routed or guided into engagement upon receipt of the primary pin within the primary aperture.

In such an embodiment, the power delivery members are preferably mounted on the rear side of the mounting wall and the power delivery contacts and the ground contact are all arranged such that manual engagement with the power delivery contacts through an aperture from a position from the front side of the mounting wall is prevented.

The primary aperture is typically adapted to receive and retain the primary pin against lateral or axial movement out of the primary aperture,

the primary pin being adapted to cooperate with the primary aperture against lateral or axial movement of the primary pin out of the primary aperture once received.

The primary pin preferably comprises a shaft and a head connected to the end of the shaft, the shaft and the head having selected configurations, the primary aperture having a first portion complementary to the head configuration for receiving the head and a second portion complementary to the shaft configuration for receiving the shaft; and,

the head of the primary pin forming an interference fit against the second portion of the primary aperture to mount the support member of the electrically powered device on the wall.

In such an embodiment the electrically powered device typically comprises an electrically powered fixture mounted to a support member;

the primary pin being rigidly connected to the support member and the primary aperture is formed in the wall of the housing; and,

the primary aperture, the pin and the power delivery member being arranged relative to each other so that the complementary mating contacts are routed into engagement with the power delivery and ground contacts upon receipt of the primary pin within the primary aperture.

The primary pin is typically rigidly connected to the electrically powered device and the primary aperture is formed within the mounting wall, the primary pin housing the complementary mating contacts of the electrically powered device, the complementary mating contacts being received through the primary aperture together with receipt of the primary pin through the primary aperture.

In such an embodiment one of the electrically powered device and the mounting wall preferably have a second pin;

the other of the electrically powered device and the mounting wall having a second aperture that receives the second pin simultaneously on receipt of the primary pin by the primary aperture; and,

the primary and second pins and the primary and second apertures being arranged such that the complementary mating contacts and the power delivery and ground contacts are guided into engagement with each other upon receipt of the primary and second pins within their corresponding primary and second apertures.

The pins are preferably attached to the electrically powered device and the apertures are disposed in the wall of the housing.

Most preferably, the plurality of apertures disposed within the mounting wall are arranged such that the primary and second pins of the electrically powered device are receivable within a plurality of different pairs of the plurality of apertures, additional power delivery members being mounted on the rear side of the mounting wall in an arrangement to enable engagement of the mating contacts with power delivery contacts via each one of the plurality of apertures.

The electrically powered device typically has a third pin, the complementary mating contacts being housed within the third pin, the third pin being receivable through a complementary aperture formed in the wall of the housing, the primary, second and complementary apertures being arranged on the wall and the primary, second and third pins being arranged on the support member such that the pins are all receivable within the apertures to route or guide the complementary mating contacts into engagement with the power delivery contacts upon receipt of the pins within the apertures.

The mounting wall preferably has a plurality of apertures disposed within the wall in an arrangement such that the primary and second and complementary pins of the electrically powered device are receivable within a plurality of different sets of three of the plurality of apertures.

At least two of the pins and the respective apertures in which the at least two pins are received are preferably adapted to receive and retain the at least two pins against lateral or axial movement out of the respective apertures.

Most preferably, the system includes at least two power delivery members arranged on the rear side of the mounting wall such that at least two electrically powered devices are independently mountable in a stable position on the front side of the mounting where the complementary mating contacts of the two electrically powered devices are all engaged with a corresponding power delivery and ground contact of the two respective power delivery members when each of the at least two electrically powered devices are fully mounted in the stable position on the front side of the mounting wall.

Each of the power delivery contacts of each of the power delivery members is preferably connected to a common source of electrical power. The complementary mating contacts of the electrically powered device preferably include a spring mechanism that maintains the mating contacts in engagement with the power delivery and ground contact.

Most preferably, the mounting wall comprises a thin sheet of rigid material having a height and a width and one or more struts disposed at one more vertically spaced positions along the height, the struts being attached to multiple positions extending across the width of the sheet.

The select arrangement of the power delivery contacts and the ground contact of the electrical power delivery member is preferably selected such that the ground contact of the power delivery member engages with a complementary mating contact of the electrically powered device before the power delivery contacts of the power delivery member engage with a complementary mating contact of the electrically powered device during the course of the electrically powered device being mounted on the front side of the mounting wall.

The housing typically includes electrical wiring mounted in, on or to the housing such that the mounting wall, the power delivery members and the electrical wiring form an interconnected housed system, the electrical wiring interconnecting each of the power delivery members to a common source of power.

In such a system, a plurality of electrically powered devices are typically mountable on the mounting wall, each of the plurality of electrically powered devices having a primary and a second pin that are receivable within a plurality of different sets of complementary apertures in the mounting wall.

In another aspect of the invention there is provided a method of mounting an electrically powered device having power receiving contacts for mounting and powering of the device on a display housing having a mounting wall having a front surface and a rear surface, the method comprising:

attaching a primary pin to the electrically powered device in a select position relative to the complementary mating contacts;

mounting one or more power delivery members having power delivery contacts on the rear surface of the mounting wall in a select arrangement;

forming a series of apertures in the mounting wall that are adapted to receive and retain the pin of the electrically powered device upon receipt;

arranging the formed apertures on the mounting wall of the housing in an arrangement that is complementary to the select arrangement of the power delivery members mounted on the rear surface such that the mating contacts of the electrically powered device are guided or routed into engagement with the power delivery contacts upon receipt of the pin through a primary aperture formed in the wall; and,

inserting the pin of the electrically powered device into the primary aperture on the front surface of the mounting wall and guiding the mating contacts into engagement with the power delivery contacts during the inserting of the primary pin.

Preferably the method further comprises:

providing the power delivery member with a ground contact; and,

guiding a mating contact of the electrically powered device into engagement with the ground contact of the power delivery member prior to guiding the other mating contacts into engagement with the power delivery contacts during the inserting.

Most preferably, the method further comprises forming the primary aperture into a configuration that prevents lateral or axial movement of the pin out of the primary aperture on receipt of the pin within the primary aperture.

In another aspect of the invention there is provided, an electrical power distribution and mounting system, the system comprising:

a housing comprising a mounting wall having a front side, a rear side and a plurality of apertures arranged in a select pattern;

a power delivery member mounted on the rear side of the mounting wall, the power delivery member including power delivery contacts and a ground contact aligned with the plurality of apertures in the mounting wall and arranged on the power delivery member in a select arrangement;

one or more electrically powered devices including complementary mating contacts projecting from the electrically powered device in an arrangement that is complementary to the select arrangement of the power delivery and ground contacts of the power delivery member;

each electrically powered device being mountable in a stable position on the front side of the mounting wall such that the mating contacts projecting from the electrically powered device extend through an aperture in the mounting wall and engage with a corresponding power delivery contact and ground contact of the power delivery member when the electrically powered device is fully mounted in the stable position; and,

wherein one of the electrically powered device and the mounting wall have a primary pin;

the other of the electrically powered device and the mounting wall having a primary aperture that is adapted to receive and retain the primary pin against lateral or axial movement out of the primary aperture; and,

wherein the complementary mating contacts and the power delivery contacts and ground contact are routed or guided into engagement upon receipt of the primary pin within the primary aperture.

The power delivery members are typically mounted on the rear side of the mounting wall and the power delivery contacts and the ground contact are all arranged such that manual engagement with the power delivery contacts through an aperture from a position from the front side of the mounting wall is prevented. The primary aperture is preferably adapted to receive and retain the primary pin against lateral or axial movement out of the primary aperture, the primary pin being adapted to cooperate with the primary aperture against lateral or axial movement of the primary pin out of the primary aperture once received.

In such an embodiment, the primary pin preferably comprises a shaft and a head connected to the end of the shaft, the shaft and the head having selected configurations, the primary aperture having a first portion complementary to the head configuration for receiving the head and a second portion complementary to the shaft configuration for receiving the shaft; and, the head of the primary pin forming an interference fit against the second portion of the primary aperture to mount the support member of the electrically powered device on the wall.

Most preferably, the electrically powered device comprises an electrically powered fixture mounted to a support member;

the primary pin being rigidly connected to the support member and the primary aperture is formed in the wall of the housing; and,

the primary aperture, the pin and the power delivery member being arranged relative to each other so that the complementary mating contacts are routed into engagement with the power delivery and ground contacts upon receipt of the primary pin within the primary aperture.

The primary pin is typically rigidly connected to the electrically powered device and the primary aperture is formed within the mounting wall, the primary pin housing the complementary mating contacts of the electrically powered device, the complementary mating contacts being received through the primary aperture together with receipt of the primary pin through the primary aperture.

Most preferably, one of the electrically powered device and the mounting wall have a second pin;

the other of the electrically powered device and the mounting wall having a second aperture that receives the second pin simultaneously on receipt of the primary pin by the primary aperture; and,

the primary and second pins and the primary and second apertures being arranged such that the complementary mating contacts and the power delivery and ground contacts are guided into engagement with each other upon receipt of the primary and second pins within their corresponding primary and second apertures.

In such an embodiment, the pins are preferably attached to the electrically powered device and the apertures are disposed in the mounting wall of the housing.

Most preferably, the plurality of apertures disposed within the mounting wall are arranged such that the primary and second pins of the electrically powered device are receivable within a plurality of different pairs of the plurality of apertures, additional power delivery members being mounted on the rear side of the mounting wall in an arrangement to enable engagement of the mating contacts with power delivery contacts via each one of the plurality of apertures.

Typically the electrically powered device has a third pin, the complementary mating contacts being housed within the third pin, the third pin being receivable through a complementary aperture formed in the wall of the housing, the primary, second and complementary apertures being arranged on the wall and the primary, second and third pins being arranged on the support member such that the pins are all receivable within the apertures to route or guide the complementary mating contacts into engagement with the power delivery contacts upon receipt of the pins within the apertures.

Most preferably, the mounting wall has a plurality of apertures disposed within the wall in an arrangement such that the primary and second and complementary pins of the electrically powered device are receivable within a plurality of different sets of three of the plurality of apertures.

Typically, at least two of the pins and the respective apertures in which the at least two pins are received are adapted to receive and retain the at least two pins against lateral or axial movement out of the respective apertures.

In such an embodiment, the system preferably includes at least two power delivery members arranged on the rear side of the mounting wall such that at least two electrically powered devices are independently mountable in a stable position on the front side of the mounting where the complementary mating contacts of the two electrically powered devices are all engaged with a corresponding power delivery and ground contact of the two respective power delivery members when each of the at least two electrically powered devices are fully mounted in the stable position on the front side of the mounting wall.

Preferably, each of the power delivery contacts of each of the power delivery members is connected to a common source of electrical power.

Most preferably, the complementary mating contacts of the electrically powered device include a spring mechanism that maintains the mating contacts in engagement with the power delivery and ground contact.

Preferably, the mounting wall comprises a thin sheet of rigid material having a height and a width and one or more struts disposed at one more vertically spaced positions along the height, the struts being attached to multiple positions extending across the width of the sheet.

Typically, the select arrangement of the power delivery contacts and the ground contact of the electrical power delivery member are selected such that the ground contact of the power delivery member engages with a complementary mating contact of the electrically powered device before the power delivery contacts of the power delivery member engage with a complementary mating contact of the electrically powered device during the course of the electrically powered device being mounted on the front side of the mounting wall.

The housing typically includes electrical wiring mounted in, on or to the housing such that the mounting wall, the power delivery members and the electrical wiring form an interconnected housed system, the electrical wiring interconnecting each of the power delivery members to a common source of power.

A plurality of electrically powered devices are preferably mountable on the mounting wall, each of the plurality of electrically powered devices having a primary and a second pin that are receivable within a plurality of different sets of complementary apertures in the mounting wall.

The housing preferably includes electrical wiring mounted in, on or to the housing such that the mounting wall, the power delivery members and the electrical wiring form an interconnected housed system, the electrical wiring interconnecting each of the power delivery members to a common source of power.

In accordance with another aspect of the invention there is provided a housing system that houses the electrical power distribution components of the system while simultaneously providing structural support and a means to distribute the electrical power to the electrically powered device to be displayed to potential customers in a retail environment for retail sale. This aspect of the invention also generally provides for a modular visual display or backdrop that enhances the display of the devices mounted on the system. The system further provides for re-configuration of the system for complete replacement or change in existing devices being displayed on the system.

In one embodiment of the invention there is provided a system for mounting and displaying electrically powered objects, the system comprising:

one or more electrically powered devices each having a base having two or more mounting pins protruding from the base in a select pattern;

a housing having a front mounting wall having a front side, a rear side and a plurality of apertures arranged in a pattern complementary to the select pattern of the the mounting pins protruding from the base of the devices such that the two or more mounting pins of the base are simultaneously insertable through two apertures from the front side of the mounting wall;

the mounting pins and the apertures being adapted for mechanical retention of the received mounting pins against lateral or axial movement of the pins out of the apertures;

a plurality of electrical power delivery contacts being arranged on the rear side of the mounting wall for electrically conductive engagement with corresponding contacts on the electrically powered device in or during the course of receipt of the mounting pins.

In such a system, the power delivery contacts include a positive, negative and ground contact and the corresponding contacts of the devices include corresponding positive, negative and ground receiving contacts, the ground, positive and negative contacts of the power delivery contacts being arranged and mounted on the rear side of the mounting wall and the positive, negative and ground receiving contacts being arranged and mounted on the devices so that as the mounting pins are received within corresponding apertures, the ground receiving contact of the device forms contact with the power delivery ground contact prior to the positive or negative receiving contacts of the device form contact with the positive or negative contacts of the power delivery contacts.

In another aspect of the invention there is provided an apparatus for delivering electrical power to an electrically powered device, the apparatus comprising:

a plurality of electrical power delivery contacts arranged for contacting a plurality of corresponding contacts on the electrically powered device;

a ground contact arranged for contacting a corresponding contact on the electrically powered device;

wherein the ground contact is arranged relative to the plurality of electrical power delivery contacts so that as the electrically powered device is connected to the apparatus, the ground contact forms contact with the corresponding contact of the device prior to the plurality of electrical power delivery contacts forming contact with the plurality of corresponding contacts of the device.

Such an apparatus typically further comprises a single unitary support on which the plurality of electrical power delivery contacts and the ground contact are mounted and a housing defining a cavity therein, the plurality of electrical power delivery contacts and the ground contact being positioned within the cavity of the housing. A portion of the housing typically comprises an aperture adjacent the plurality of electrical power delivery contacts and the ground contact, the ground contact being positioned closer to the portion of the housing than the plurality of power delivery contacts.

Further in accordance with the invention there is provided an apparatus for delivering electrical power to an electrically powered device, the apparatus comprising: a plurality of electrical power delivery contacts arranged for contacting a plurality of corresponding contacts on the electrically powered device; and,

means for electrically grounding the electrically powered device, the means being arranged so that as the electrically powered device is connected to the apparatus, the electrically powered device is grounded prior to the plurality of electrical power delivery contacts forming contact with the plurality of corresponding contacts of the device.

In another aspect of the invention there is provided an apparatus for delivering electrical power to an electrically powered device, the apparatus comprising: a plurality of electrical power delivery contacts arranged for contacting a plurality of corresponding contacts of the electrically powered device;

a housing defining a cavity therein, the plurality of electrical power delivery contacts being positioned within the cavity;

one of the electrically powered device and the housing including a guide member and the other of the electrically powered device and the housing including an aperture arranged for receiving and retaining the guide member;

wherein the plurality of electrical power delivery contacts are arranged so that as the guide member is received within the aperture, the plurality of corresponding contacts of the electrically powered device are guided into contact with the plurality of electrical power delivery contacts.

In such an apparatus, the aperture is configured to receive the guide member and the plurality of corresponding contacts of the electrically powered device as the electrically powered device is connected to the apparatus.

Further in accordance with the invention there is provided a method of providing an apparatus for delivering electrical power to an electrically powered device, the method comprising:

providing a housing defining a cavity therein;

providing a plurality of electrical power delivery contacts arranged for contacting a plurality of corresponding contacts of the electrically powered device within the cavity of the housing;

providing one of the electrically powered device and the housing with a guide member and forming an aperture in the other of the electrically powered device and the housing for receiving and retaining the guide member;

arranging the plurality of electrical power delivery contacts so that as the guide member is received within the aperture, the plurality of corresponding contacts of the electrically powered device are guided into contact with the plurality of electrical power delivery contacts.

Such a method typically further comprises configuring the aperture to be able to receive the guide member and the plurality of corresponding contacts of the electrically powered device.

In one embodiment of the invention there is provided an electrical power distribution system for mounting one or more electrically powered devices for display on the system, the system comprising:

a housing comprising opposing walls interconnected to each other to define an enclosed interior space;

a power delivery member mounted within the interior space of the housing, the power delivery member including power delivery contacts and a ground contact, each electrically powered device including a mating contact that is complementary to each of the contacts of the power supply member;

wherein the electrically powered device is mountable in a stable position on a wall of the housing such that the complementary mating contacts of the device are all engaged with a respective corresponding power delivery and ground contact of the power delivery member when the device is fully mounted in the stable position; and,

the electrical power delivery member being arranged within the interior space of the housing such that the ground contact of the power delivery member engages with a complementary mating contact of the electrically powered device before the power delivery contacts of the power delivery member engage with a complementary mating contact of the electrically powered device during the course of the electrically powered device being mounted on the wall.

Such a system typically includes at least two power delivery members arranged within the interior space of the housing such that at least two electrically powered devices are independently mountable in a stable position on each of the opposing walls of the system such that the complementary mating contacts of the two electrically powered devices are all engaged with a corresponding power delivery and ground contact of the two respective power delivery members when each of the at least two electrically powered devices are fully mounted in the stable position on each of the opposing walls. The power delivery members are typically mounted within the interior space of the housing such that manual engagement with the power delivery contacts from a position outside the interior space is prevented. The power delivery members are typically mounted within the interior space of the housing in an arrangement that enables engagement of all of the complementary mating contacts of the plurality of electrically powered devices with a corresponding power delivery and ground contact of a corresponding power delivery member when each of the plurality of electrically powered devices are fully mounted in a stable position on the wall. The power delivery contacts of each of the power delivery members are typically connected to a common source of electrical power.

In such a system of the electrically powered device can comprise: a power receiving element mounted on a support member;

the power receiving element being connected to the complementary mating contacts;

the support member including a first mount member that mates with a complementary second mount member contained in or on the wall of the housing; and,

the first and second mount members being arranged such that upon mating of the respective mount members, the complementary mating contacts of the powered device are routed into electrically conductive engagement with the power delivery and ground contacts of the power delivery members of the housing.

In such system, the electrically powered device can comprise:

a power receiving element mounted on a support member; the power receiving element being connected to the complementary mating contacts;

the support member including a first mount member that mates with a complementary second mount member contained in or on the wall of the housing; and, the first and second mount members being arranged such that upon mating of the respective mount members, the complementary mating contacts of the powered device are routed into electrically conductive engagement with the power delivery and ground contacts of the power delivery members of the housing.

The housing typically includes an electrical power inlet and an electrical power outlet, the electrical power inlet receiving electrical power from an original source, the electrical power inlet being electrically interconnected and delivering power from the source to the power delivery members within the housing and to the electrical outlet.

Such a system can further comprise a second housing having an electrical power inlet interconnected to the electrical power outlet of the other housing, the inlet of the second housing being interconnected to and delivering power from the original source to one or more electrical power delivery members mounted within the second housing.

In such a system, the power delivery member can comprise:

a positive contact, a negative contact and a ground contact; and,

the positive, negative and ground contacts being mounted on an electrically non-conductive support member in an arrangement such that a complementary mating contact of the electrically powered device engages the ground contact prior to engagement of another complementary mating contact with the positive or negative contacts upon mounting of the electrically powered device on the wall of the housing.

In such a system, the electrically powered device can include a mounting pin on which the complementary mating contacts are mounted, the mounting pin being adapted to house or embed one or more of the complementary mating contacts within a recess or aperture formed by wall portions of the pin that shield the one or more complementary mating contacts from ambient physical contact with external objects or surfaces, the mounting pin having an axis and being receivable through an aperture in the mounting wall to route the complementary mating contacts into conductive contact with power delivery contacts arranged in alignment with the aperture, the complementary mating contacts being adapted to mate with the power delivery contacts under a radially outwardly directed spring force.

In such system two or more housings can be interconnected together in an arrangement to form a structure that is mountable on a ground or floor surface in a free-standing stable position with the walls disposed in a generally vertical disposition. The complementary mating contacts of the electrically powered device typically include a spring mechanism that maintains the mating contacts in engagement with the power delivery and ground contact.

In such a system, the electrically powered device can comprise:

a power receiving fixture mounted on a support member, the power receiving fixture being connected to the complementary mating contacts;

one of the support member and the wall of the housing having a primary pin; and,

the other of the support member and the wall having a primary aperture that is adapted to receive and retain the primary pin against lateral or axial movement out of the primary aperture.

The primary pin is typically adapted to cooperate with the primary aperture against lateral or axial movement of the primary pin out of the primary aperture once received.

The primary pin comprises a shaft and a head connected to the end of the shaft, the shaft and the head having selected configurations, the primary aperture having a first portion complementary to the head configuration for receiving the head and a second portion complementary to the shaft configuration for receiving the shaft; and,

the head of the primary pin forming an interference fit against the second portion of the primary aperture to mount the support member of the electrically powered device on the wall. The primary pin is typically rigidly connected to the support member and the primary aperture is formed in the wall of the housing, the aperture, the pin and the power delivery member being arranged relative to each other so that the mating contacts are routed into engagement with the power delivery and ground contacts upon receipt of the primary pin within the primary aperture. The primary pin is rigidly connected to the support member and the primary aperture is formed within the wall of the housing, and wherein the primary pin houses the complementary mating contacts of the electrically powered device, the complementary mating contacts being received through the primary aperture together with receipt of the primary pin through the primary aperture.

One of the support members and the wall of the housing preferably has a second pin;

the other of the support member and the wall have a second aperture that receives the second pin; and,

the primary and second pins and the primary and second apertures being arranged such that the complementary mating contacts and the power delivery and ground contacts are guided into engagement with each other upon receipt of the primary and second pins within their corresponding primary and second apertures. The pins are typically attached to the support member and the apertures are disposed in the wall of the housing.

The wall of the housing preferably has a plurality of apertures disposed within the wall in an arrangement such that the primary and second pins of the support member are receivable within a plurality of different pairs of the plurality of apertures, the interior of the housing having additional power delivery members mounted within the interior of the housing in an arrangement to enable engagement of the mating contacts with power delivery contacts via each one of the plurality of apertures. The support member typically has a third pin attached to the support member, the complementary mating contacts being housed within the third pin, the third pin being receivable through a complementary aperture formed in the wall of the housing, the primary, second and complementary apertures being arranged on the wall and the primary, second and third pins being arranged on the support member such that the pins are all receivable within the apertures to route or guide the complementary mating contacts into engagement with the power delivery and ground contacts upon receipt of the pins within the apertures.

The wall of the housing typically has a plurality of apertures disposed within the wall in an arrangement such that the primary and second and complementary pins of the support member are receivable within a plurality of different sets of three of the plurality of apertures. At least two of the pins and the respective apertures in which the at least two pins are received are adapted to receive and retain the at least two pins against lateral or axial movement out of the respective apertures.

In another embodiment of the invention, there is provided an electrical power distribution system for mounting one or more electrically powered devices for display on the system, the system comprising:

a housing comprising opposing walls interconnected to each other to define an enclosed interior space;

a power delivery member mounted within the interior space of the housing, the power delivery member including power delivery contacts;

each electrically powered device having mating contacts that are complementary to each of the contacts of the power supply member;

one of the electrically powered device and the wall of the housing having a primary pin;

the other of the electrically powered device and the wall having a primary aperture that is adapted to receive and retain the primary pin against lateral or axial movement out of the primary aperture; and,

wherein the complementary mating contacts and the power delivery strips are arranged within the interior of the housing such that the complementary mating contacts are routed or guided into engagement with the power delivery strips upon receipt of the primary pin within the primary aperture.

The primary aperture is preferably adapted to receive and retain the primary pin against lateral or axial movement out of the primary aperture, the primary pin being adapted to cooperate with the primary aperture against lateral axial movement of the primary pin out of the primary aperture once received. The primary pin preferably comprises a shaft and a head connected to the end of the shaft, the shaft and the head having selected configurations, the primary aperture having a first portion complementary to the head configuration for receiving the head and a second portion complementary to the shaft configuration for receiving the shaft; and, the head of the primary pin forming an interference fit against the second portion of the primary aperture to mount the support member of the electrically powered device on the wall.

In such a system the electrically powered device preferably comprises an electrically powered fixture mounted to a support member;

the primary pin being rigidly connected to the support member and the primary aperture is formed in the wall of the housing; and,

the aperture, the pin and the power delivery member being arranged relative to each other so that the mating contacts are routed into engagement with the power delivery and ground contacts upon receipt of the primary pin within the primary aperture.

Preferably in such a system the primary pin is rigidly connected to the electrically powered device and the primary aperture is formed within the wall of the housing, and the primary pin houses the complementary mating contacts of the electrically powered device, the complementary mating contacts being received through the primary aperture together with receipt of the primary pin through the primary aperture.

Typically in such a system, one of the electrically powered device and the wall of the housing have a second pin;

the other of the support member and the wall have a second aperture that receives the second pin; and,

the primary and second pins and the primary and second apertures being arranged such that the complementary mating contacts and the power delivery and ground contacts are guided into engagement with each other upon receipt of the primary and second pins within their corresponding primary and second apertures.

The pins are preferably attached to the electrically powered device and the apertures are disposed in the wall of the housing.

In such a system, the wall of the housing has a plurality of apertures disposed within the wall in an arrangement such that the primary and second pins of the electrically powered device are receivable within a plurality of different pairs of the plurality of apertures, the interior of the housing having additional power delivery members mounted within the interior of the housing in an arrangement to enable engagement of the mating contacts with power delivery contacts via each one of the plurality of apertures. The electrically powered device preferably has a third pin, the complementary mating contacts being housed within the third pin, the third pin being receivable through a complementary aperture formed in the wall of the housing, the primary, second and complementary apertures being arranged on the wall and the primary, second and third pins being arranged on the support member such that the pins are all receivable within the apertures to route or guide the complementary mating contacts into engagement with the power delivery contacts upon receipt of the pins within the apertures.

In such a system, the wall of the housing typically has a plurality of apertures disposed within the wall in an arrangement such that the primary and second and complementary pins of the electrically powered device are receivable within a plurality of different sets of three of the plurality of apertures.

In such a system, at least two of the pins and the respective apertures in which the at least two pins are received are adapted to receive and retain the at least two pins against lateral or axial movement out of the respective apertures.

Further in accordance with the invention there is provided, a method of mounting an electrically powered device having power receiving contacts for mounting and powering of the device on a display housing having a display wall and an interior space, the method comprising:

attaching a primary pin to the electrically powered device in a select position relative to the complementary mating contacts;

mounting one or more power delivery members having power delivery contacts in the interior space of the housing in a select arrangement;

forming a series of apertures in the wall that are adapted to receive and retain the pin of the electrically powered device upon receipt;

arranging the formed apertures on the wall of the housing in an arrangement that is complementary to the select arrangement of the power delivery members mounted within the interior space such that the mating contacts of the electrically powered device are guided or routed into engagement with the power delivery contacts upon receipt of the pin through a primary aperture formed in the wall; and, inserting the pin of the electrically powered device into the primary aperture and guiding the mating contacts into engagement with the power delivery contacts during the inserting of the primary pin.

Such a method preferably further comprises:

providing the power delivery member with a ground contact; and,

guiding a mating contact of the electrically powered device into engagement with the ground contact of the power delivery member prior to guiding the other mating contacts into engagement with the power delivery contacts during the inserting.

Such a method typically further comprises:

housing the mating contacts of the electrically powered device within a second pin attached to the device; and,

inserting the second pin within a second aperture during the step of inserting the primary pin within the primary aperture.

Such a method preferably further comprises:

forming the primary pin into a shaft and a head attached to a distal end of the shaft, the shaft being attached at a proximal end to the electrically powered device;

forming the head into a select configuration;

forming the primary aperture into a configuration having a head portion that is complementary to receipt of the select configuration of the head and a shaft portion that is complementary to receipt of the shaft, the shaft portion being narrower than a cross section of the head;

inserting the head of the primary pin fully through the head portion of the primary aperture; and,

sliding the shaft of the primary pin through the shaft portion of the primary aperture.

Such a method preferably further comprises:

enclosing the power delivery members within the interior space against manual access, the power delivery members comprising the power delivery contacts mounted on an electrically non-conductive support; and,

mounting the power delivery contacts on the electrically non-conductive support in an arrangement that disposes the power delivery contacts in a position that is manually inaccessible through the apertures in the wall of the housing.

Further in accordance with the invention there is provided an apparatus for delivering electrical power to an electrically powered device, the apparatus comprising:

a housing comprising a mounting wall and side walls rigidly attached to the mounting wall, the mounting wall having a front side, a rear side, a width from side to side and a height from top to bottom;

the electrically powered device being mounted on or to the front side of the mounting wall;

one or more elongated struts attached to the rear side of the mounting wall at a plurality positions across the width of the mounting wall;

a plurality of electrical power delivery contacts arranged on the rear side of the wall for contacting a plurality of corresponding contacts on the electrically powered device;

a ground contact arranged on the rear side of the mounting wall for contacting a corresponding contact on the electrically powered device; and,

wherein the power delivery contacts and the ground contact are arranged relative to the plurality of electrical power delivery contacts so that when the electrically powered device is mounted on or to the front side of the mounting wall, the power delivery contacts and the ground contact engage in conductive contact with the corresponding contacts of the electrically powered device.

In such an apparatus the power delivery contacts and the ground contact are typically mounted in sets on one or more unitary non-conductive supports that are mounted on or to the struts on the rear side of the mounting wall. At least two struts are typically attached to the rear of the mounting wall, the struts being disposed at selected positions along the height of the mounting wall. At least two non-conductive supports having a plurality of power delivery and ground contacts mounted thereon are preferably mounted across the width of the mounting wall. The struts are preferably rigidly attached to one or both of the side walls and one or both of the side walls are formed as flanges to the front wall.

In such an apparatus the housing is typically enclosed and has an interior enclosed space in which the supports are mounted, the power delivery contacts being manually inaccessible within the interior space. The mounting wall preferably has a plurality of apertures arranged in a pattern relative to the power delivery and ground contacts such that the corresponding contacts of the electrically powered device are receivable through the apertures into conductive contact with the power delivery and ground contacts.

In such an apparatus, the mounting wall typically has a plurality of apertures and electrically powered device includes at least one mounting pin, the apertures in the mounting wall being configured and arranged such that the mounting pin of the electrically powered device is readily receivable through and retainable within an aperture to mount the electrically powered device on the wall when the wall is disposed in an upright position. The electrically powered device preferably includes at least one mounting pin, the apertures in the mounting wall being configured and arranged such that the mounting pin of the electrically powered device is readily receivable through and retainable within an aperture to mount the electrically powered device on the wall when the wall is disposed in an upright position. The electrically powered device preferably includes at least two mounting pins, the apertures in the mounting wall being arranged such that the at least two pins are simultaneously receivable through and retainable within separate apertures.

Apparatus for mounting and delivering electrical power to an electrically powered device, the apparatus comprising:

a housing comprising a mounting wall comprising a thin sheet of metal having a generally planar configuration, a front side, a rear side, a width from side to side and a height from top to bottom;

the electrically powered device having a weight being mounted on or to the front side of the mounting wall, the mounting wall bearing the weight of the device;

one or more elongated struts attached to the rear side of the mounting wall at a plurality of positions extending across the width of the mounting wall selected to reinforce the thin sheet of metal against substantial bending out of the generally planar configuration under the weight of the device mounted on the mounting wall;

a plurality of electrical power delivery contacts arranged on the rear side of the wall for contacting a plurality of corresponding contacts on the electrically powered device;

a ground contact arranged on the rear side of the mounting wall for contacting a corresponding contact on the electrically powered device; and,

wherein the power delivery contacts and the ground contact are arranged relative to the plurality of electrical power delivery contacts so that when the electrically powered device is mounted on or to the front side of the mounting wall, the power delivery contacts and the ground contact engage in conductive contact with the corresponding contacts of the electrically powered device.

In such an embodiment, the mounting wall preferably has a plurality of apertures and the electrically powered device includes at least one mounting pin, the apertures in the mounting wall being configured and arranged such that the mounting pin of the electrically powered device is readily receivable through and retainable within an aperture against the weight of the device to mount the electrically powered device on the wall when the wall is disposed in an upright position. The corresponding contacts of the device are preferably readily receivable through an aperture in the mounting wall to engage in conductive contact with the power delivery contacts on receipt of the mounting pin through an aperture in the mounting wall.

In another embodiment of the invention there is provided an apparatus for delivering electrical power to an electrically powered device, the apparatus comprising:

a housing comprising a mounting wall having a front side, a rear side, a width from side to side and a height from top to bottom;

the electrically powered device having a weight and being mountable on or to the front side of the mounting wall, the mounting wall bearing the weight of the device;

one or more elongated struts attached to the rear side of the mounting wall at a plurality of positions across the width of the mounting wall;

the mounting wall having a plurality of apertures and the electrically powered device including at least one mounting pin, the apertures in the mounting wall being configured and arranged such that the mounting pin of the electrically powered device is readily receivable through and retainable within an aperture against the weight of the device to mount the electrically powered device on the wall when the wall is disposed in an upright position; and,

the device being connected to a source of power on mounting of the device to the wall.

In such an embodiment, a plurality of electrical power delivery contacts are preferably arranged on the rear side of the wall for contacting a plurality of corresponding contacts on the electrically powered device, the power delivery contacts being connected to the source of power;

a ground contact is arranged on the rear side of the mounting wall for contacting a corresponding contact on the electrically powered device; and,

wherein the power delivery contacts and the ground contact are arranged relative to the plurality of electrical power delivery contacts so that when the electrically powered device is mounted on or to the front side of the mounting wall, the power delivery contacts and the ground contact engage in conductive contact with the corresponding contacts of the electrically powered device.

The corresponding contacts of the electrically conductive device are preferably readily receivable through an aperture in the mounting wall to engage in conductive contact with the power delivery contacts on receipt of the mounting pin through an aperture in the mounting wall.

At least two struts are preferably attached to the rear side of the wall at different selected positions along the height of the wall and the apparatus preferably includes at least two non-conductive support members on which are mounted the power delivery and ground contacts, the support members being mounted on or to the struts in an arrangement such that power delivery and ground contacts are aligned with the apertures for ready engagement of the corresponding contacts of the device with the power delivery and ground contacts on receipt of the pin through an aperture in the wall.

In another embodiment of the invention there is provided, an apparatus for delivering electrical power to an electrically powered device, the apparatus comprising:

a housing comprising a mounting wall having a front side, a rear side, a width from side to side and a height from top to bottom;

the electrically powered device having a weight and being mountable on or to the front side of the mounting wall, the mounting wall bearing the weight of the device;

a selected number of at least two elongated struts attached to the rear side of the mounting wall at a plurality of attachment positions extending across the width of the mounting wall, the selected number being a minimum of the number of successive struts that can be attached along the height of the wall such that the maximum distance between the closest points of attachment between successive struts is about 18 inches;

the mounting wall having a plurality of apertures and the electrically powered device including at least one mounting pin, the apertures in the mounting wall being configured and arranged such that the mounting pin of the electrically powered device is readily receivable through and retainable within an aperture against the weight of the device to mount the electrically powered device on the wall when the wall is disposed in a generally vertically upright position; and,

the device being connected to a source of power on mounting of the device to the wall.

In such an apparatus preferably the maximum distance between the closest points of attachment between successive struts is about 16 inches and the mounting wall has a thickness of between about 0.04 to about 0.08 inches.

In another embodiment of the invention there is provided an apparatus for delivering electrical power to one or more electrically powered devices for mounting and visual display of the devices, the apparatus comprising:

two or more housings each comprising a generally planar mounting wall having a front side and a rear side and side walls forming an enclosed interior space within the housings;

the electrically powered devices being readily mountable on or to and detachable from the front sides of the mounting walls;

a plurality of electrical power delivery contacts arranged within the interior of the housings on the rear side of the walls for contacting a plurality of corresponding contacts on the electrically powered devices;

wherein the power delivery contacts are arranged relative to the plurality of electrical power delivery contacts so that when the electrically powered devices are mounted on or to the front side of the mounting walls, the power delivery contacts engage in conductive contact with the corresponding contacts of the electrically powered devices;

wherein a sidewall of each of the at least two housings is mechanically interconnected to a sidewall of another one of the housings in an arrangement wherein the generally planar mounting walls are disposed at a selected obtuse or acute angle relative to each other; and,

wherein the angle of disposition is selected to enable the connected housings to be seated in the angled disposition on a ground surface in a stable generally vertically upright disposition.

In such an apparatus, the angle of disposition is preferably selected to be between about 10 and about 170 degrees, more preferably between about 20 and about 160 degrees and most preferably between about 25 and about 155 degrees.

In such an apparatus, the mounting walls preferably have a plurality of apertures and the electrically powered devices preferably include at least one mounting pin, the apertures in the mounting walls being configured and arranged such that the mounting pins of the electrically powered device are readily receivable through and retainable within an aperture to mount the electrically powered devices on the wall when the walls are disposed in the generally vertically upright position.

In such an apparatus the electrically powered device preferably includes at least two mounting pins, the apertures in the mounting wall being arranged such that the at least two pins are simultaneously receivable through and retainable within separate apertures. The mounting wall preferably has a plurality of apertures arranged in a pattern relative to the power delivery contacts such that the corresponding contacts of the electrically powered device are receivable through the apertures into conductive contact with the power delivery contacts on mounting of the devices to the mounting walls.

In another embodiment of the invention there is provided, an apparatus for delivering electrical power to one or more electrically powered devices for mounting and visual display of the devices, the apparatus comprising:

a housing comprising a mounting wall having a front side and a rear side and side walls forming an enclosed interior space within the housing;

the electrically powered devices being readily mountable on or to and detachable from the front side of the mounting wall;

a plurality of electrical power delivery contacts arranged within the interior of the housings on the rear side of the walls for contacting a plurality of corresponding contacts on the electrically powered devices;

wherein the power delivery contacts are arranged relative to the plurality of electrical power delivery contacts so that when the electrically powered devices are mounted on or to the front side of the mounting walls, the power delivery contacts engage in conductive contact with the corresponding contacts of the electrically powered devices;

wherein a single source of power is interconnected in series to successive sets of of electrical power delivery contacts.

The single source of power is typically interconnected in series to the successive sets of power delivery contacts and further in series to an electrical outlet. The mounting wall preferably has successive sets of a plurality of apertures, the successive sets of power delivery contacts being arranged in alignment with the successive sets of a plurality of apertures, the corresponding contacts of one or more electrically powered devices being insertable through an aperture to engage in conductive contact with a set of the power delivery contacts aligned with the aperture.

In such an embodiment, corresponding contacts of at least two electrically powered devices are insertable through at least two apertures of a single set of apertures to conductively engage a single set of power delivery contacts aligned with the single set of apertures. Most preferably, the successive sets of power delivery contacts are each separately mounted on a corresponding elongated non-conductive support member mounted within the enclosed interior space of the housing, each non-conductive support member having an end disposed in an enclosed sub-housing within the enclosed interior space of the housing, each end of each of the support members being interconnected to a corresponding electrical connector that is electrically interconnected to a corresponding set of power delivery contacts mounted on a corresponding support member, the electrical connectors being interconnected to each other in successive series and housed within the sub-housing.

Further in accordance with the invention there is provided a system for mounting and displaying one or more electrically powered devices comprising: a housing having a front mounting wall, an enclosed interior space, a top, a bottom, sides and an exterior;

two or more sets of positive and a negative power delivery contacts mounted within the enclosed interior space;

the electrically powered devices being mountable on the front mounting wall, each device having corresponding contacts that are engageable in conductive contact with a set power delivery contacts on mounting of a device on the front mounting wall;

the two or more sets of positive and negative power delivery contacts being interconnected in series to a source of power that delivers power to all of the interconnected power delivery contacts in series.

In such a system, preferably one or more electrical outlets are interconnected to and draw power from the power source together with the two or more sets of positive and negative power delivery contacts, the one or more electrical outlets being mounted at any one or more of the top, bottom or sides of the housing and being manually accessible for conductive connection to electrically conductive contacts from the exterior of the housing. Most preferably, the two or more sets of power delivery contacts are interconnected to the power source within an enclosed space of a sub-housing disposed within the enclosed interior space of the housing.

In such a system the enclosed sub-housing includes a panel or door or wall that is manually accessible from the exterior of the housing and readily removable from or readily openable to provide manual access to the enclosed space of the sub-housing.

In another embodiment of the invention there is provided a system for mounting and displaying one or more electrically powered devices comprising: a housing having a front mounting wall, an enclosed interior space, a top, a bottom, sides and an exterior;

the front mounting wall having a plurality of apertures;

the electrically powered devices having mounting pins receivable through an aperture to mount the devices on the front mounting wall;

two or more sets of positive and a negative power delivery contacts mounted within the enclosed interior space, each set being arranged within the interior space in alignment with a plurality of the apertures in the mounting wall for receipt of a set of corresponding contacts mounted on the electrically powered device, the corresponding contacts being adapted for conductive engagement with the power delivery contacts on mounting of a device to the front mounting wall;

the two or more sets of positive and negative power delivery contacts being interconnected in series to a source of power that delivers power to all of the interconnected power delivery contacts.

In such a system, preferably one or more electrical outlets are interconnected to and draw power from the power source together with the two or more sets of positive and negative power delivery contacts, the one or more electrical outlets being mounted at any one or more of the top, bottom or sides of the housing and being manually accessible for conductive connection to electrically conductive contacts from the exterior of the housing. Most preferably, the two or more sets of power delivery contacts are interconnected to the power source within an enclosed space of a sub-housing disposed within the enclosed interior space of the housing.

In such a system the enclosed sub-housing includes a panel or door or wall that is manually accessible from the exterior of the housing and readily removable from or readily openable to provide manual access to the enclosed space of the sub-housing.

The surface of the front mounting wall of all of the systems and apparati described herein is comprised of a material, typically metal such as steel, that receives and retains visually identifiable printing material such as paint, paper, ink and the like. Images and artwork can be imprinted on the surface of the front mounting wall using conventional methods of printing such as inkjet printing, embossing, screen printing, spray painting, laser printing and the like.

In another aspect of the invention there is provided an apparatus for mounting and delivering electrical power to an electrically powered device, the apparatus comprising:

a housing comprising a mounting wall comprising a thin sheet of metal having a generally planar configuration, a front side, a rear side, a width from side to side, a height from top to bottom and a plurality of apertures arranged in a select arrangement;

the electrically powered device having a weight and being mounted on or to the front side of the mounting wall, the mounting wall bearing the weight of the electrically powered device;

one or more elongated struts attached to the rear side of the mounting wall at a plurality of positions extending across the width of the mounting wall, the plurality of attachment positions being selected to reinforce the thin sheet of metal against substantial bending out of the generally planar configuration under the weight of the electrically powered device upon mounting on the mounting wall;

a plurality of electrical power delivery members having power delivery and ground contacts,

the electrically powered device having corresponding power receiving and ground contacts,

the power delivery members being arranged on the rear side of the mounting wall and the power delivery and ground contacts being arranged on the power delivery members in a select arrangement relative to the plurality of apertures in the mounting wall such that the power receiving and ground contacts of the electrically powered device are insertable through an aperture in the mounting wall to conductively engage the power delivery contacts and the ground contact of a power delivery member upon mounting of the electrically powered device on the front side of the mounting wall;

wherein the select arrangement of the power delivery contacts and the ground contact of the electrical power delivery member is selected such that the ground contact of the power delivery member engages with a complementary mating contact of the electrically powered device before the power delivery contacts of the power delivery member engage with a complementary mating contact of the electrically powered device during the course of the electrically powered device being mounted on the front side of the mounting wall.

In another aspect of the invention there is provided an apparatus for mounting and delivering electrical power to an electrically powered device, the apparatus comprising:

a housing comprising a mounting wall comprising a thin sheet of metal having a generally planar configuration, a front side, a rear side, a width from side to side, a height from top to bottom and a plurality of apertures arranged in a select arrangement;

the electrically powered device having a weight and being mounted on or to the front side of the mounting wall, the mounting wall bearing the weight of the electrically powered device;

one or more elongated struts attached to the rear side of the mounting wall at a plurality of positions extending across the width of the mounting wall, the plurality of attachment positions being selected to reinforce the thin sheet of metal against substantial bending out of the generally planar configuration under the weight of the electrically powered device upon mounting on the mounting wall;

a plurality of electrical power delivery members having power delivery and ground contacts,

the electrically powered device having corresponding power receiving and ground contacts,

each electrically powered device being mountable in a stable position on the front side of the mounting wall and each power delivery member being mounted on the rear side of the mounting wall in an arrangement such that the mating contacts projecting from the electrically powered device extend through one or more selected ones of the apertures in the mounting wall and engage with a corresponding power delivery contact and ground contact of a power delivery member when the electrically powered device is fully mounted in the stable position; and,

wherein one of the electrically powered device and the mounting wall have a primary pin;

the other of the electrically powered device and the mounting wall having a primary aperture that is adapted to receive and retain the primary pin against lateral or axial movement out of the primary aperture; and,

wherein the power receiving and ground contacts of the electrically powered device are routed or guided into engagement with the power delivery contacts and ground contact of the power delivery member upon receipt of the primary pin within the primary aperture.

### BRIEF DESCRIPTION OF THE DRAWINGS

FIG. 1 is perspective view of a system according to the invention showing two display panels electrically connected to each other, each of which has one or more electrically powered devices mounted on a wall surface of the panels via a mounting system according to the invention;

FIG. 2 is a sectional view taken along line 2-2 of FIG. 1;

FIG. 3 is a sectional view taken along line 3-3 of FIG. 1;

FIG. 4 is an exploded partially sectional perspective view of the portion of the FIG. 1 system shown in FIGS. 2 and 3;

FIG. 5 is an exploded perspective view of a power delivery member component of the FIG. 1 system showing an embodiment of the mounting of the support member for the positive and negative and ground electrical delivery contact components of the system;

FIG. 6 is a front exploded perspective view of an embodiment of an electrically powered device showing the device comprised of a light fixture mounted to a support member;

FIG. 7 is a front exploded perspective view of the support member and electrical receiving contact components of the FIG. 6 electrically powered device showing details of the arrangement and configuration of the electrical contacts and their mounting on the support member;

FIG. 8 is a side cross sectional view of a portion of the system of FIG. 1 showing the electrical receipt contact components of the electrically powered device in a first position upon initial insertion of the contact component through a complementary receiving aperture in a wall of one of the panels where the positive and negative receipt contacts are spring biased to be urged toward each other into contact with the power delivery contacts;

FIG. 8a is a side cross sectional view of a portion of an alternative to the system of FIG. 1 showing the electrical receipt contact components of the electrically powered device in a first position upon initial insertion of the contact component through a complementary receiving aperture in a wall of one of the panels where the positive and negative receipt contacts are spring biased to be urged away from each other into contact with the power delivery contacts;

FIG. 9 is top cross sectional view along the center of the FIG. 8 positional view showing an initial position, upon initial insertion into a panel aperture, of the positive, negative and ground receipt contacts of the electrically powered device relative to the positive, negative and ground delivery contacts of a power delivery member mounted within one of the panels of the FIG. 1 system;

FIG. 9a is top cross sectional view along the center of the FIG. 8a positional view showing an initial position, upon initial insertion into a panel aperture, of the positive, negative and ground receipt contacts of the electrically powered device relative to the positive, negative and ground delivery contacts of a power delivery member mounted within one of the panels of the FIG. 1 system;

FIG. 9b is a perspective schematic view of the FIGS. 8a and 9a electrically powered device showing the corresponding positive and negative contacts embedded within a slot provided in a central guide pin or protrusion for physical protection of the contacts;

FIG. 10 is a side cross sectional view similar to FIG. 8 showing a subsequent position of more advanced insertion of the receipts contact components of the electrically powered device through a complementary receiving aperture in a wall of one of the panels;

FIG. 10a is a side cross sectional view similar to FIG. 8a showing a subsequent position of more advanced insertion of the receipts contact components of the electrically powered device through a complementary receiving aperture in a wall of one of the panels;

FIG. 11 is top cross sectional view along the center of the FIG. 10 positional view showing more details of the subsequent more advanced insertion position of the receipt contacts of the electrically powered device relative to the delivery contacts of the power delivery member, in particular showing that the ground contacts of the receipt and delivery members are guided into electrically conductive contact with each other prior to the positive and negative contacts of the receipt and delivery members coming into conductive contact with each other during the course of insertion of the receipt contacts through the wall aperture;

FIG. 11a is top cross sectional view along the center of the FIG. 10a positional view showing more details of the subsequent more advanced insertion position of the receipt contacts of the electrically powered device relative to the delivery contacts of the power delivery member, in particular showing that the ground contacts of the receipt and delivery members are guided into electrically conductive contact with each other prior to the positive and negative contacts of the receipt and delivery members coming into conductive contact with each other during the course of insertion of the receipt contacts through the wall aperture;

FIG. 12 is a side cross sectional view similar to FIG. 10 showing a further more advanced and essentially final insertion position of the receipt contact components of the electrically powered device through the complementary receiving aperture in the wall of one of the panels;

FIG. 12a is a side cross sectional view similar to FIG. 10a showing a further more advanced and essentially final insertion position of the receipt contact components of the electrically powered device through the complementary receiving aperture in the wall of one of the panels;

FIG. 13 is top cross sectional view along the center of the FIG. 12 positional view showing more details of the final insertion position of the receipt contacts of the electrically powered device relative to the delivery contacts of the power delivery member, in particular showing that all of the receipt and delivery members have been guided into electrically conductive contact with each other upon final fully advanced insertion of the receipt contacts through the wall aperture;

FIG. 13a is top cross sectional view along the center of the FIG. 12a positional view showing more details of the final insertion position of the receipt contacts of the electrically powered device relative to the delivery contacts of the power delivery member, in particular showing that all of the receipt and delivery members have been guided into electrically conductive contact with each other upon final fully advanced insertion of the receipt contacts through the wall aperture;

FIG. 14 is a side view of an embodiment of a system according to the invention showing a single panel having readily attachable and detachable mounting members for mounting the panel in a vertically disposed position from an overhead or ceiling mount member;

FIG. 15 is an exploded perspective cut away view of the top, middle and bottom sections of a panel of the FIG. 14 embodiment showing details of the routing of the electrical power delivery wiring through a top compartment of the panel and showing mechanical connecting components of the top, middle and bottom housing components of the system;

FIG. 16 is a side view of an embodiment of a system according to the invention showing two overhead mounted panels electrically connected to each other in a side end to side end configuration, and showing the power wiring extending laterally from side to side along the length of both the top and bottom compartments of the two panels;

FIG. 17 is a perspective exploded view of the top compartment end of a panel component of a system according to the invention showing electrical input and output connector components on opposing side ends of the top compartment and showing an example of the components and arrangement of readily connectable and disconnectable overhead mounting arrangement similar to the overhead mounting arrangement shown in FIGS. 15 and 16;

FIG. 18 is a perspective view of an alternative wiring connector component extending from the end of the top compartment of a panel component of a system according to the invention;

FIG. 19 is a perspective view of three panels according to the invention that are mechanically connected along their side edges in one exemplary arrangement that enables the connected panels to be mounted on their bottom ends in a stable free-standing position on a floor or ground surface for use as a display for devices mounted on one or more of the walls of the system;

FIG. 20 is a perspective view of three panels according to the invention that are mechanically connected along their side edges in another exemplary arrangement that enables the connected panels to be mounted on their bottom ends in a stable free-standing position on a floor or ground surface for use as a display for devices mounted on one or more of the walls of the system;

FIG. 21 is a side cross sectional view of a portion of an alternative embodiment of the system of FIG. 1 showing the electrical receipt contact components of the electrically powered device in a first position upon initial insertion of the contact component through a complementary receiving aperture in a wall of one of the panels, the ground receiving contact in this embodiment having a longer length than the ground contact of the FIGS. 8-13 embodiment such that the ground contact bends at its distal end against the ground delivery member contact;

FIG. 22 is top cross sectional view along the center of the FIG. 21 positional view showing an initial position, upon initial insertion into a panel aperture, of the positive, negative and ground receipt contacts of the electrically powered device relative to the positive, negative and ground delivery contacts of a power delivery member mounted within one of the panels of the FIG. 1 system;

FIG. 23 is a side cross sectional view similar to FIG. 21 showing a subsequent position of more advanced insertion of the receipts contact components of the electrically powered device through a complementary receiving aperture in a wall of one of the panels showing the distal end of the ground receiving contact in a partially bent position on contact with the ground delivery contact;

FIG. 24 is top cross sectional view along the center of the FIG. 23 positional view showing more details of the subsequent more advanced insertion position of the receipt contacts of the electrically powered device relative to the delivery contacts of the power delivery member, in particular showing that the ground contacts of the receipt and delivery members are guided into electrically conductive contact with each other prior to the positive and negative contacts of the receipt and delivery members coming into conductive contact with each other during the course of insertion of the receipt contacts through the wall aperture;

FIG. 25 is a side cross sectional view similar to FIG. 23 showing a further more advanced and essentially final insertion position of the receipt contact components of the electrically powered device through the complementary receiving aperture in the wall of one of the panels, showing the distal end of the ground receiving contact in a fully final bent position against the ground contact of the power delivery member;

FIG. 26 is top cross sectional view along the center of the FIG. 25 positional view showing more details of the final insertion position of the receipt contacts of the electrically powered device relative to the delivery contacts of the power delivery member, in particular showing that all of the receipt and delivery members have been guided into electrically conductive contact with each other upon final fully advanced insertion of the receipt contacts through the wall aperture;

FIG. 27 is a front perspective view of a panel or housing according to the invention showing the front and side walls formed from a unitary sheet of metal;

FIG. 28 is a rear perspective view of the FIG. 27 panel showing an arrangement of power delivery strips mounted by the struts in axial alignment with successive vertical rows of apertures;

FIG. 29 is an exploded view of FIG. 28 showing the top end enclosure exploded from its position over the top wiring channel and showing an arrangement of electrical power delivery wires with serially connected circuit splitters mounted on the top ends of the power delivery members and for electrical connection of the power source to the power delivery contacts of the power delivery members;

FIG. 30 is a fragmentary enlarged view of a portion of FIG. 29 showing the arrangement and mounting configuration of the power delivery members in axial alignment with the mounting apertures of the front wall.

### DETAILED DESCRIPTION

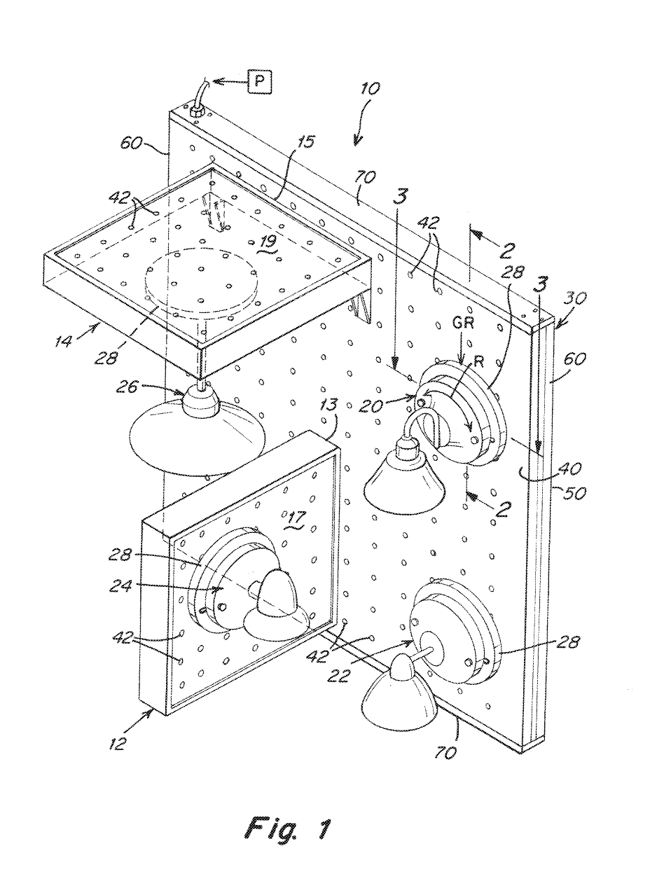

FIG. 1 shows one example of a electrical power distribution and mounting system 10 according to the invention comprised of a first power delivery and mounting panel 30 mounted in a generally vertical disposition either on a ground surface, on a wall or other support or by hanging from an overhead support (not shown). The first panel 30 is shown having two electrically powered devices 20 mounted in stable positions on the outside surface of a wall 40 having multiple spaced receiving apertures 42 positioned over/about the area of the wall 40. The panel 30 comprises a housing structure having opposing spaced mounting walls 40, sidewalls 60 and top and bottom walls 70 that collectively enclose a space 65 between the walls 40, 60, 70 that is inaccessible by hand.

As shown in FIG. 1, two electrically powered devices 20, 22, e.g. light fixtures are mounted on the wall surface 40. In addition, two separate electrical power distribution and mounting panels or housings 12, 14, constructed of the same functional components as panel 30, are mounted on or to the main panel or housing 30. As shown, the separate panels 12, 14 each have separate electrically powered devices 24, 26 mounted on/to their own exterior wall surfaces in the same manner as devices 20, 22 are mounted on or to the main panel 30. Each of the devices 20, 22 and secondary panels 12, 14 are electrically connected to a complementary power delivery member housed within the interior space of the main panel 30 such that electrical power is simultaneously delivered to all of the devices 20, 22, 24, 26 by a single original source of power.

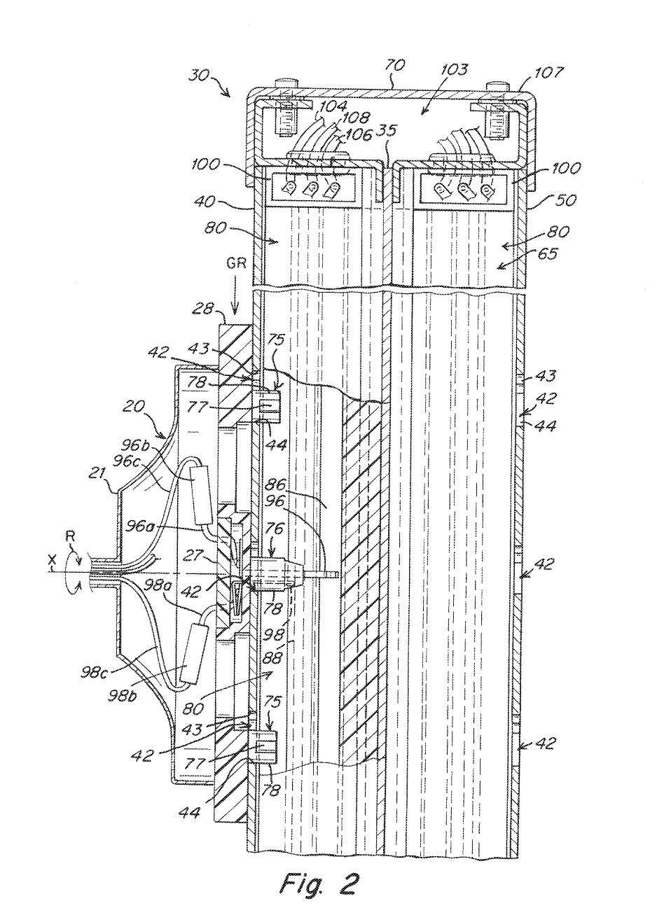

As shown in FIGS. 2-5, the electrically powered device 20 comprises an light fixture 21 mounted/connected on or to a disk or support 28 member via bolts 29 or other conventional mechanical connection mechanisms such as nails, clasps, glue, snap-together mechanism or the like. The disk member 28 is typically constructed as a generic device having preferably at least two pins, projections or keys 75, 76 (referred to generically herein as “pins”) for purposes of ensuring that the disk member 28 together with its attached device 21 is mountable in a fully stable position on or to the wall 40 of the panel 30 under the force of gravity GR, and is stable against rotation R around the axis X of the disk member 21 (FIG. 2).

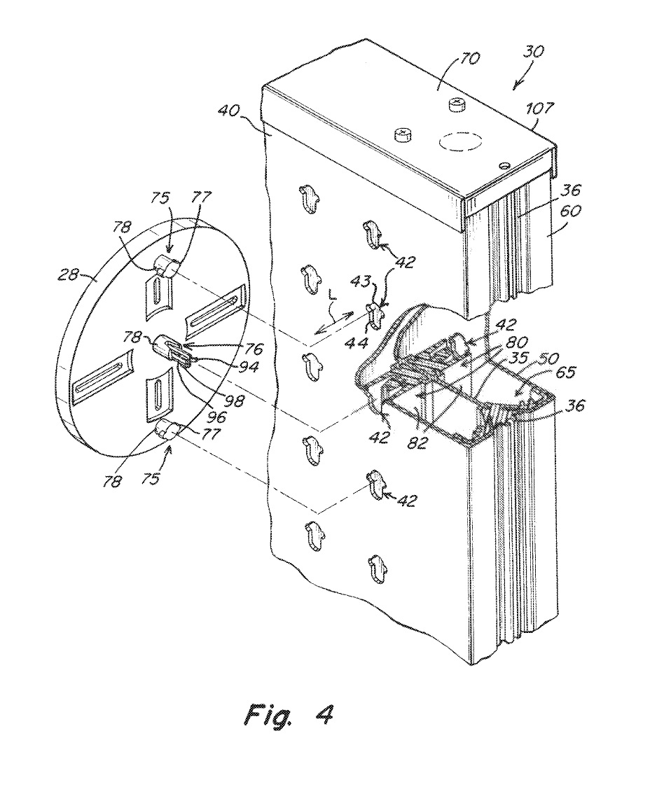

With reference to FIGS. 2-5 and particularly FIG. 4, at least one of the pins 75 is formed as a key or in a keyed configuration having a stem portion 78 and a widened head portion 77. The widened head portion 77 of the pins 75 is enlarged, the receiving apertures 42 being formed into a complementary shape such that the widened head 77 is fully and readily receivable by and through the top end 43 of the aperture 42 in the lateral direction L, and is concomitantly readily removable from the top configured end 43 in the lateral direction L. Once the head 77 is fully inserted through and received by the top end 43 of the aperture 42, the stem portion 78 can be received by and slid downwardly through a complementary slot portion 44 of the aperture 42. The stem 78 is configured to have a widest diameter or cross sectional length that is smaller than the widest diameter or cross-sectional length of the head 77 such that on sliding of the stem 78 downwardly through the narrowed slot 44, the widened head portion 77 of the pin 75 is prevented from moving laterally outwardly L from the wall 40 as a result of an interference fit or interaction of the widened head 77 against/with the edges of the slot 44.

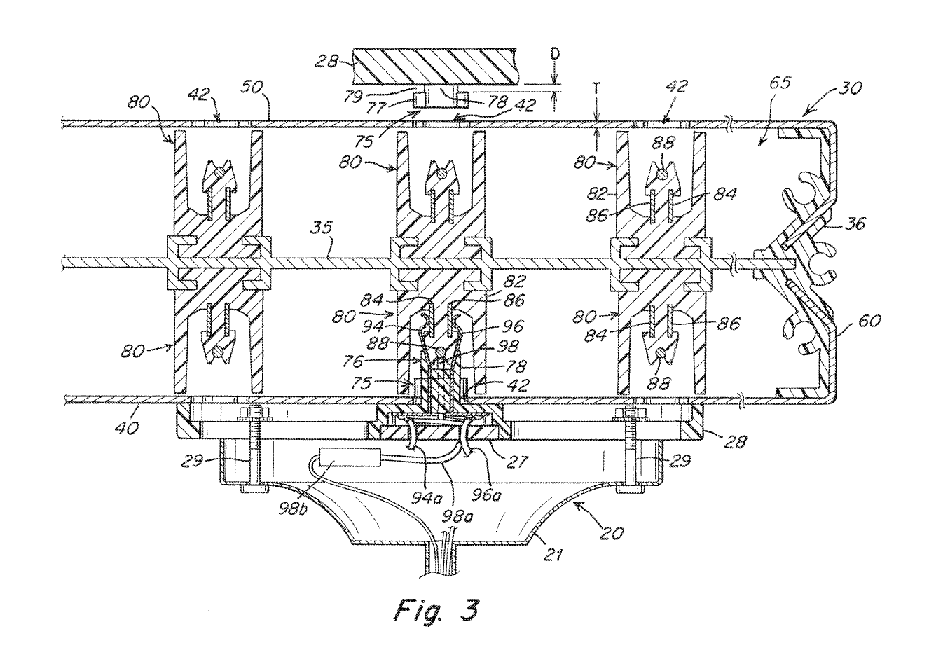

With reference to FIG. 3, the walls 40, 50 have a predetermined thickness T at least in the immediate vicinity around the edges of a mounting aperture 42. The length of the stem 78 is D. Or, stated another way, D is the axial or lateral distance of the space 79 between the axially inside facing surface of the widened head 77 and the axially outwardly facing surface of the portion of the base support 28 at the point at which the stem 78 is attached. Most preferably the thickness T and distance D are about the same, or the thickness T is slightly smaller than D by less than about 0.05 inches such that when the pin 75 is fully inserted within an aperture 42, the thickness of the walls 40, 50 around the edges of the aperture is securely or snugly fit within space or slot 79 by the opposing axially inwardly facing surface of the head 77 and the axially outwardly facing surface of the base support 28 to which the stem 78 is attached when the stem 78 is slid downwardly under the force of gravity GR.

As shown, FIGS. 3, 4, the base 28 has a generally axially aligned central pin 76 that houses the electrical contacts of the device 21 and is received within a complementary aperture 42 as shown in FIGS. 3, 4. This pin 76 is received simultaneously with receipt of pins 75 within apertures 42. As shown in the embodiments of the Figures, the axially central pin 76 comprises a stem 78 portion only and does not include a widened head 77 as pins 75 do. In an alternative embodiment, the central pin 76 could also include a widened head 77 as in the configuration of the pins 75.

In the embodiments shown in FIGS. 1-5, the base support member includes two spaced apart pins 75 and an axially central pin 76. In an alternative embodiment, the base support member could include only a single keyed or configured pin 75 which could be positioned either axially or spaced apart from the axis of the support member 28. If a mounting pin 75 having a widened head 78 is spaced apart from the axis X, then the assembly most preferably includes a second pin 76, with or without a widened/keyed head portion, that houses the electrical contacts and the connecting wires of the electrically powered device 20.

In any and all embodiments of the invention where more than one pin 75 or 76 is included, the apertures 42 are provided and arranged in an arrangement or pattern or position on the wall 40 or 50 that is complementary to the arrangement/position of the pins 75 and/or 76 on the support member 28 whereby all of the pins 75 or 76 are simultaneously insertable through and received by a corresponding aperture 42 when the support member is manually mounted to the wall 40 or 50 as shown best in FIG. 4.

In an alternative embodiment (not shown), a pin or pins 75 could be attached to the outside surface of one or the other or both of the walls 40, 50 and the support member 28 could be configured to have complementary receiving apertures of the same or similar design/configuration as apertures 42. In such an embodiment, the pins would be arranged on the surface of the wall 40, 50 in a pattern that is complementary to the arrangement/position of the apertures on the support 28 whereby at least one pin and preferably two pins on the wall 40, 50 are simultaneously insertable through and received by a corresponding aperture provided on the support 28.

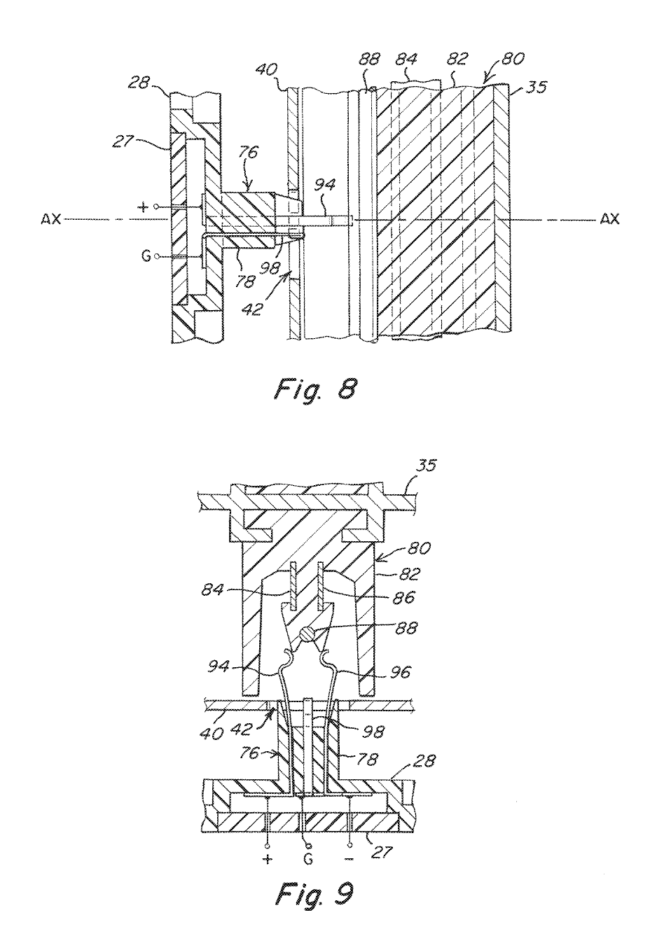

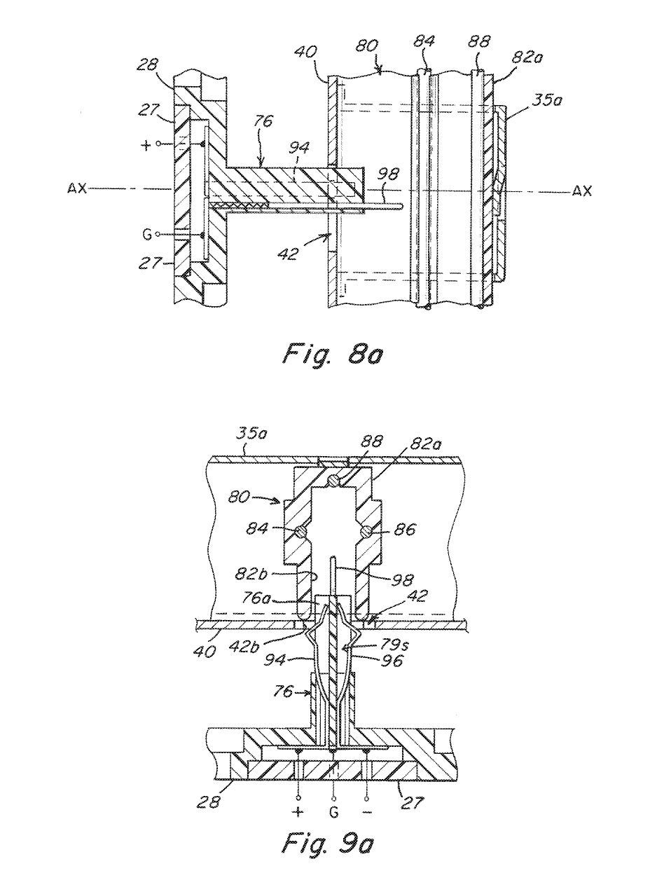

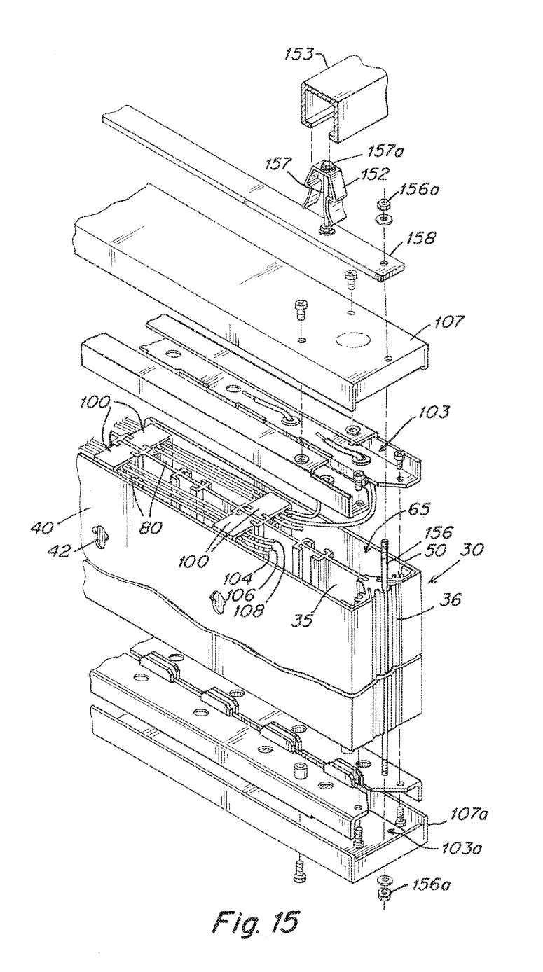

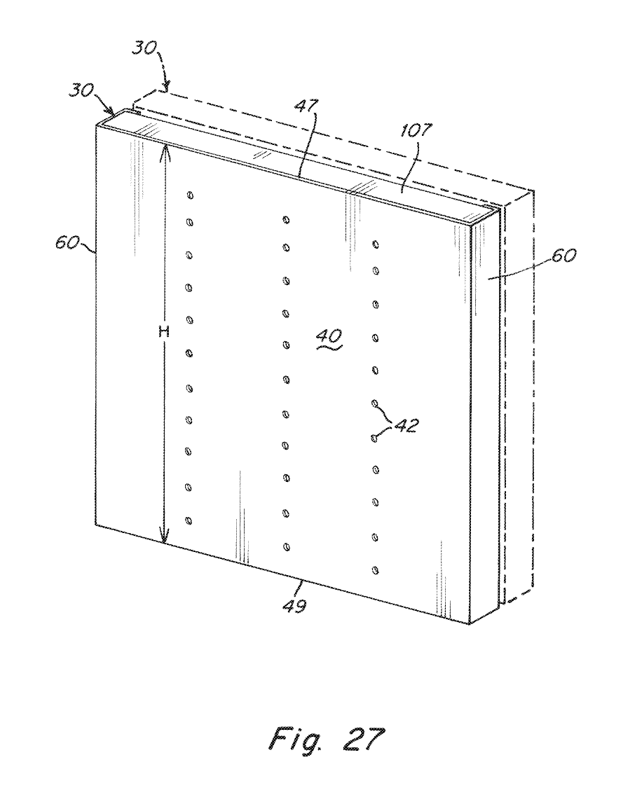

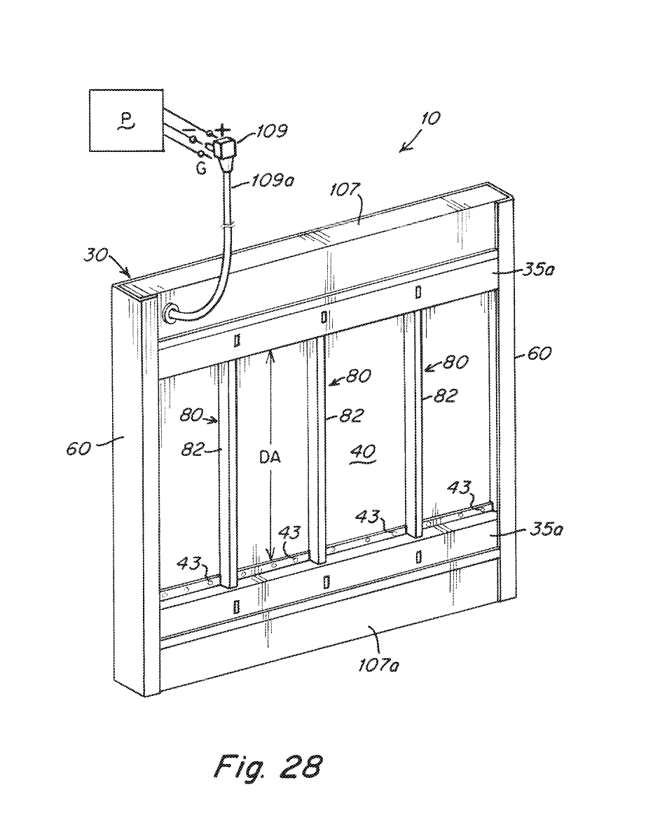

As shown in FIGS. 2-5, 8-15, power delivery members 80 are mounted and arranged within the interior space 65 of the housing 30. The power delivery members 80 comprise a base support 82, 82a, FIGS. 8, 8a of electrically non-conductive material such as plastic or wood. Electrically conductive positive and negative delivery contacts 84, 86 and ground contact 88 are mounted on the non-conductive supports 82, 82a, FIGS. 8-13. The non-conductive supports 82, 82a are mounted on or to a housing support member 35, 35a, FIGS. 8, 8a, and the delivery contacts 84, 86, 88 are mounted on or to the supports 82, 82a in an arrangement selected to align the delivery contacts 84, 86, 88 with the receiving/mounting apertures 42 so that when the electrically powered device's corresponding positive and negative 94, 96 and ground 98 receiving contacts are inserted into and received by a mounting aperture 42, the receiving contacts 94-98 will be routed and come into electrically conductive contact with the delivery contacts 84-88. As shown in the embodiment of FIGS. 27-30 support members 82 containing and mounting the power contacts 84-88 are mounted via housing members 35a in alignment with apertures 42.

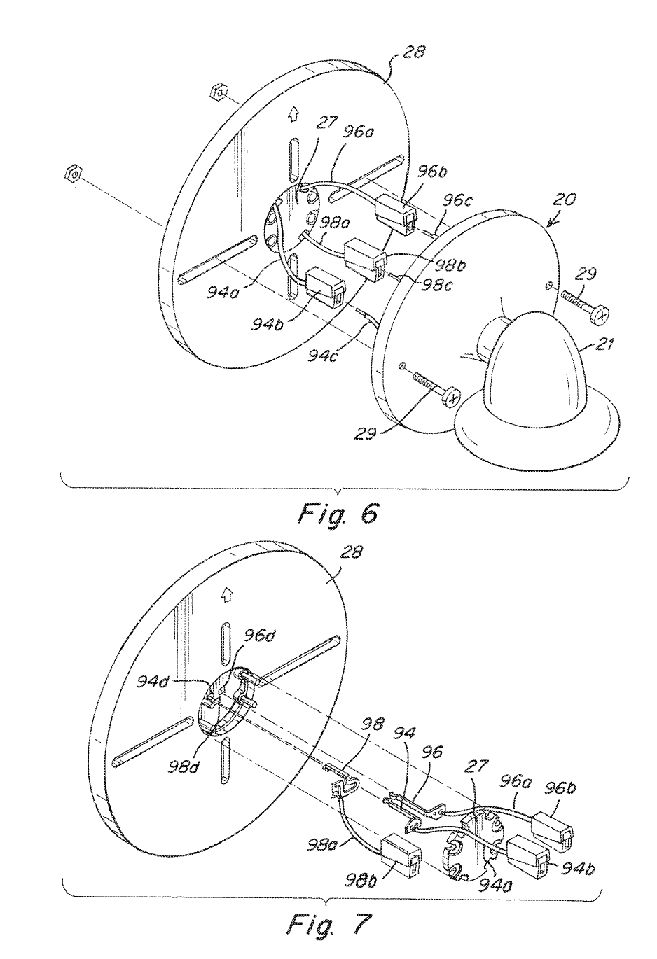

As shown in FIGS. 2, 3, 4, 6 and 7, the electrically powered device has three electrically conductive wires, feeds or connections positive, negative and ground 94c, 96c, 98c respectively that connect to connectors 94b, 96b, 98b which are in turn connected to conductive wires 94a, 96a, 98a which are in turn connected to conductive contacts 94, 96, 98 which are mechanically mounted in a stable axially projecting disposition as shown in the Figures to support member 28 with the rigid conductive projections 94, 96, 98 projecting through mounting apertures 94d, 96d, 98d provided in support member 28. A cover plate 27 is affixed over the recess in support member 28 in which the bases of the contacts are mounted to prevent hand contact and electrical shock. The cover plate has apertures for wires 94a, 96a and 98a to pass through as best seen in FIG. 6. As shown in FIGS. 8-13, the contacts 94, 96, 98 are typically housed within, surrounded by and/or mounted within the axial interior of pin 76 in a stable spatial/positional arrangement that is complementary for purposes of conductive contact/engagement with the arrangement of the delivery contacts 84, 86, 88 on their support 82, 82a.

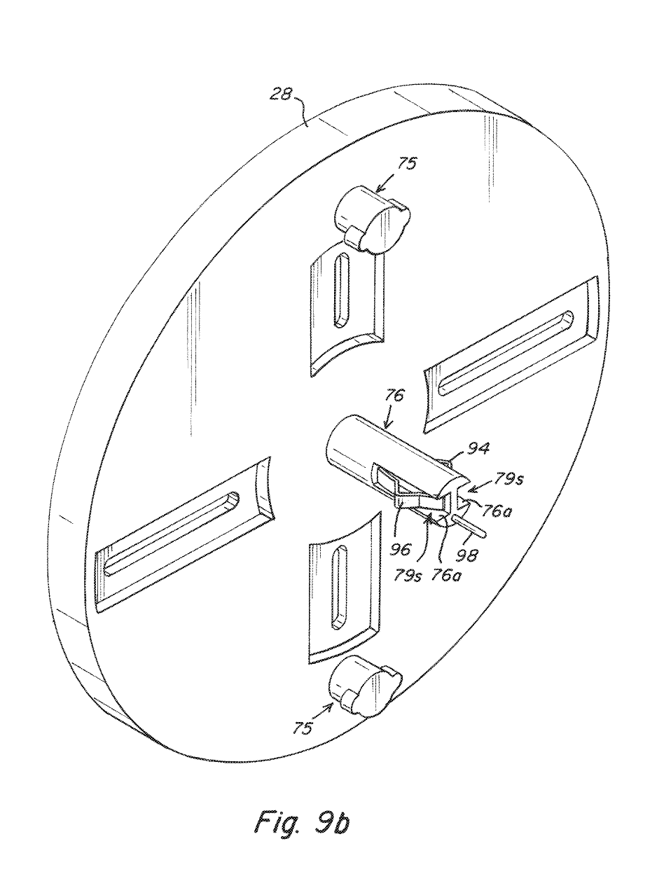

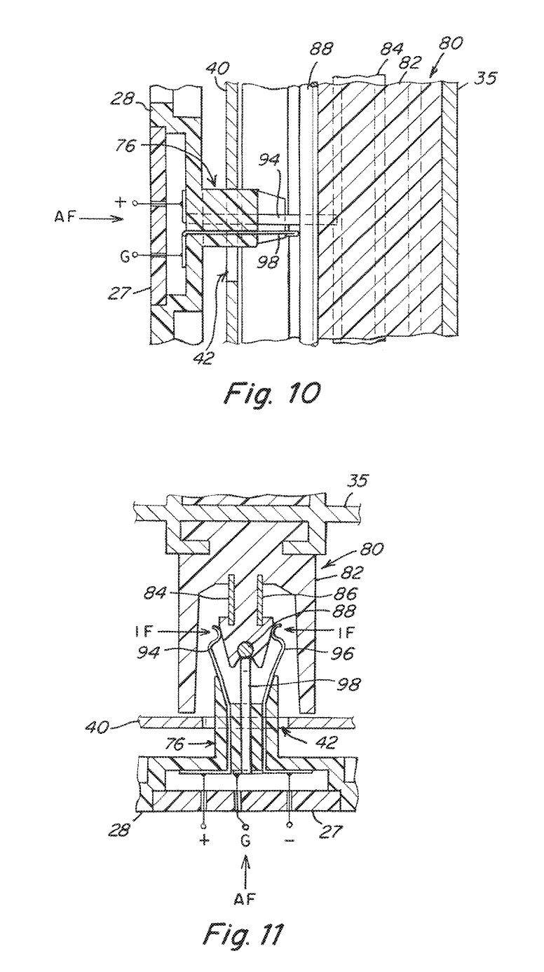

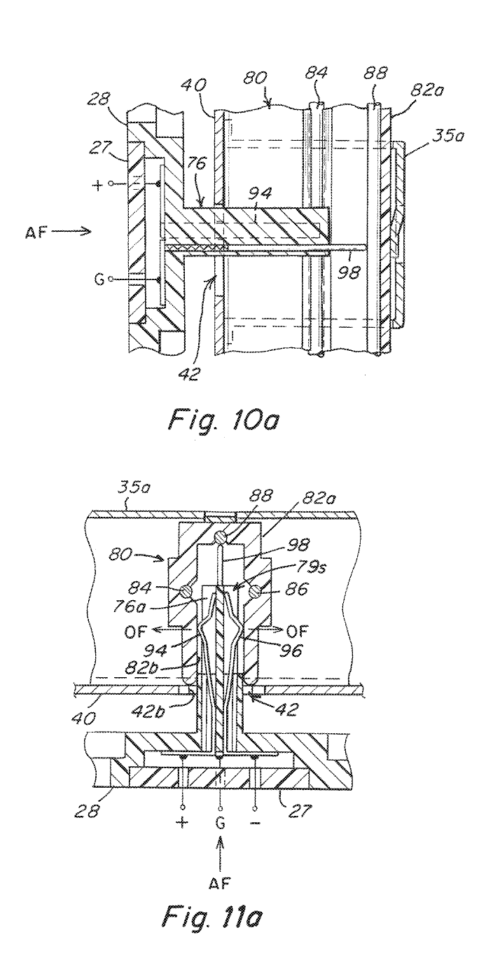

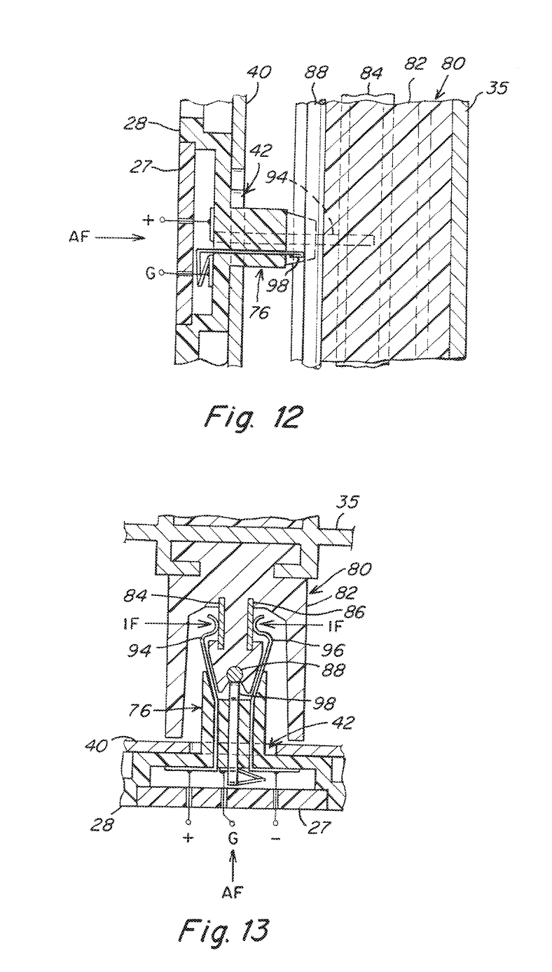

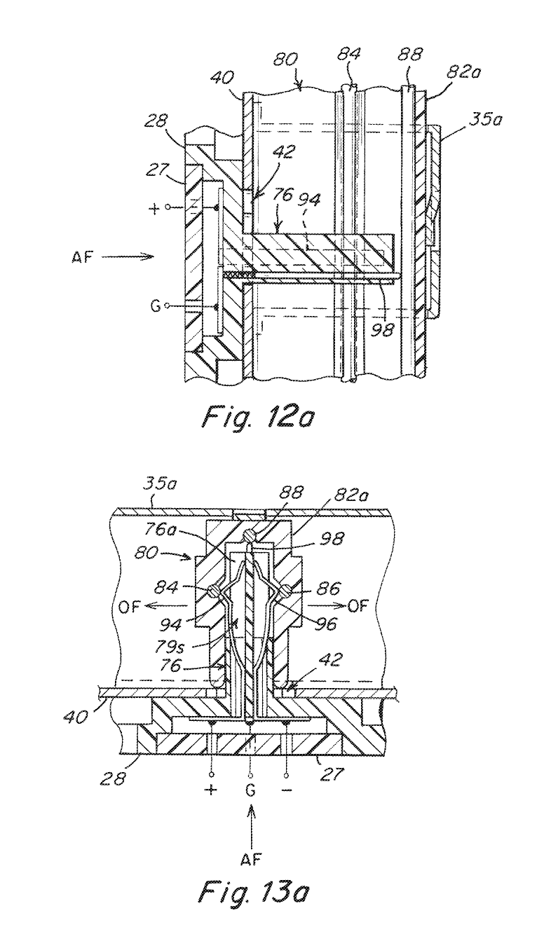

As shown in FIGS. 8, 9, 8a, 9a when a support member 28 with its attached fixture 21 is initially moved into position for mounting on wall 40, the axis of the pin 76 that houses or supports the electrical receiving contacts 94, 96, 98 is initially axially aligned with the axis AX of the aperture 42 and then manually guided generally along axis AX such that the pin 76 is inserted along the axis AX into the mounting/receiving aperture 42. In this initial insertion position, FIGS. 8, 8a, 9, 9a, none of the contacts 94, 96, 98 are yet in contact with any of the power delivery contacts 84, 86 and 88. On further insertion of the support pin 76 as shown in FIGS. 10, 10a, 11, 11a, the ground contact 98 of the fixture/device comes into contact with ground contact 88 of the power delivery device before the live positive and negative electrical delivery contacts, 84, 86 come into contact with the device positive and negative receiving contacts 94, 96. The contacts 94, 96, 98 are configured, mounted and arranged on the support pin 76 and the contact 84, 86, 88 are configured, mounted and arranged on the support 82 so that the ground contact 98 always and necessarily comes into contact/engage with the power delivery ground contact 88 before the positive and negative contacts engage/come into contact with each other. As shown in FIGS. 12, 12a, 13, 13a, when the mounting pin 76 is fully inserted into the aperture 42, the positive 84/94 and negative 86/96 contacts come into contact/engage with each other with the ground contacts 88/98 already being and remaining in contact with each other.

In and during the course of movement of the support member 28 from the position shown in FIGS. 10, 11, to the position shown in FIGS. 12, 13, the device contacts 94, 96 are forced inwardly under a radially inwardly directed spring force IF into spring loaded engagement contact with their corresponding positive and negative 84, 86 live delivery contacts. And, the ground contact 98 is maintained as shown under a spring load axial force AF with its corresponding ground contact 88.

Also, in and during the course of movement of the support member 28 from the position shown in the alternate embodiment of FIGS. 10a, 11a, to the position shown in FIGS. 12a, 13a, the device contacts 94, 96 are adapted to be spring loaded to exert a radially outwardly directed spring force OF engagement with their corresponding positive and negative 84, 86 live delivery contacts. And, the ground contact 98 is maintained as shown under a spring loaded axial force with its corresponding ground contact 88.

In the embodiment shown in FIGS. 8a, 9a, 9b, 10a, 11a, 12a, 13a, the device contacts 94, 96 are adapted to spring radially outwardly OF. The device contacts 94, 96 are typically formed of relatively thin strips of highly conductive metal material and are relatively fragile. Given their relative fragility and their mechanical engagement under a radially outwardly directed spring force OF with the edges 42b of the apertures 42 and with the interior surfaces 82b of the support members 82a, the device contacts 94, 96 are mounted to the pin protrusion 76 and arranged so as to be embedded or housed within a slot 79s formed by flanged walls 76a of pin 76. The flanged walls 76a house the contacts 94, 96 and thus mechanically protect the majority of the length of the contacts 94, 96 from significant incidental contact or axial movement that could result from physical engagement with external objects or structures that might damage their arrangement or structure such as the edges 42b of the apertures 42 or the interior wall surfaces 82b into and through which the pins 76 are inserted. As shown, the contacts 94, 96 are mounted to/on the pin 76 and are configured relative to the power delivery support 82a and interior wall surface 82b so that the contacts are forced radially inwardly toward each other on contact with the surfaces 82b and exert a constant concomitant radially outward spring force OF on the interior surfaces 82b and ultimately on the power delivery contacts 84, 86.

Simultaneously in and during the course of movement of the support 28 from the position shown in FIGS. 10, 10a, 11, 11 a to the position shown in FIGS. 12, 12a, 13, 13a, the keyed pins 75 having the enlarged heads 77 are simultaneously inserted into corresponding mounting apertures 42, with the heads 77 first being inserted through the enlarged aperture portions 43 and then subsequently the stems 78 being slid vertically downwardly through the narrowed slot portion 44 of the apertures 42. As noted, the pin 76 that mounts the contacts 94, 96, 98 could be configured with a head 77 and stem 78 and mounted to apertures 42 in the same manner as pins 75 are mounted to apertures

On complete, full or final insertion of the pins 75, 76 into their corresponding apertures 42, the support 28 and its attached fixture 21 is fully mounted in a stable position on the wall 40 against rotation X and against falling downwardly under the force of gravity GR. Concurrently, the device/fixture 21 is fully electrically connected/engaged to the live electrical contacts 84, 86 which are in turn connected to an original source of electrical power that powers the electrically powered device 20. Thus an electrical power connection is made concurrently or simultaneously in/during the course of a single manual motion that mounts the electrically powered device 20 on the wall 40.

The physical size and shape of the apertures 42 is preferably selected to obstruct or prevent a human finger from being capable of penetrating through the apertures 42 such that finger/manual contact with the live delivery contacts 84, 86 cannot be made.

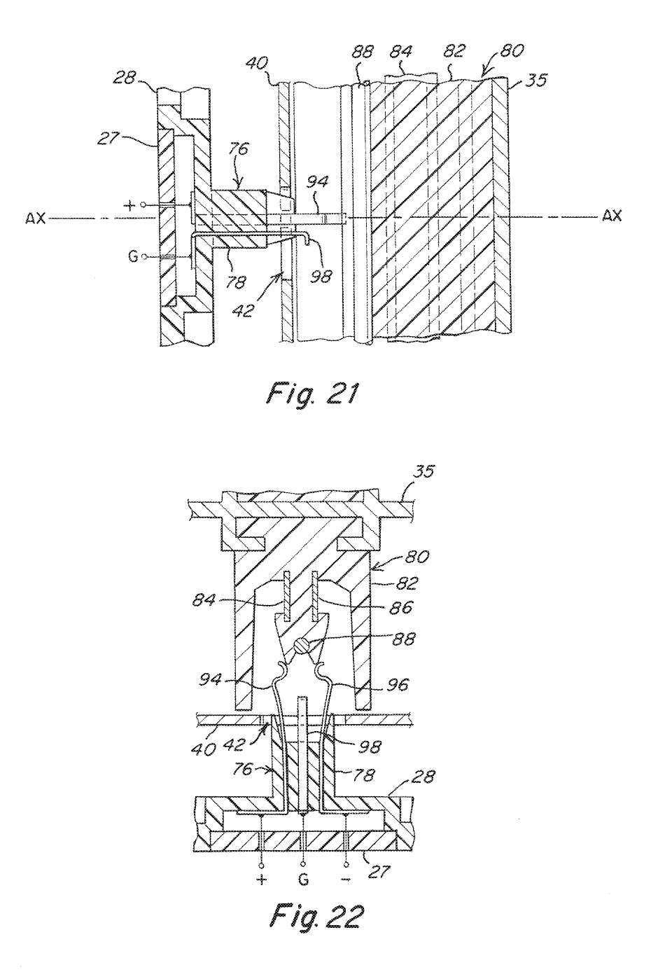

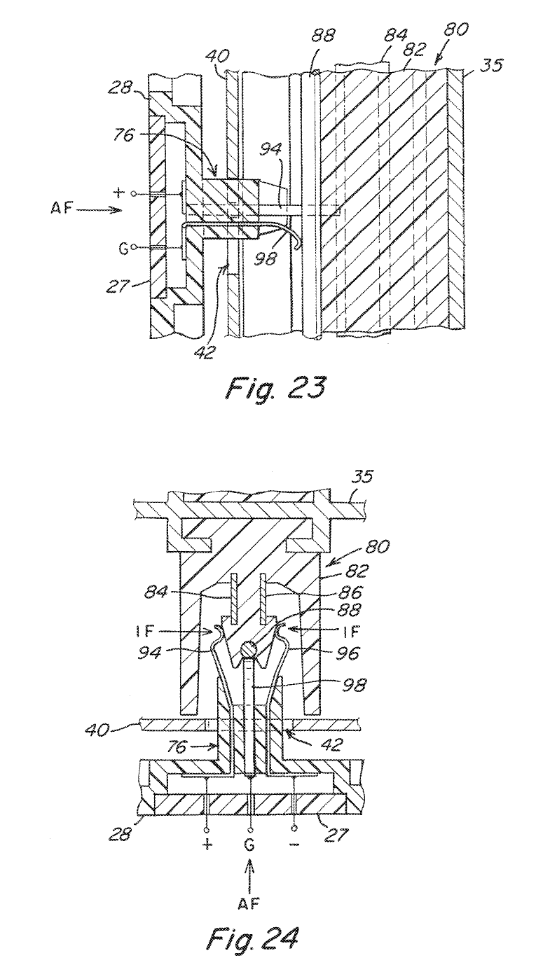

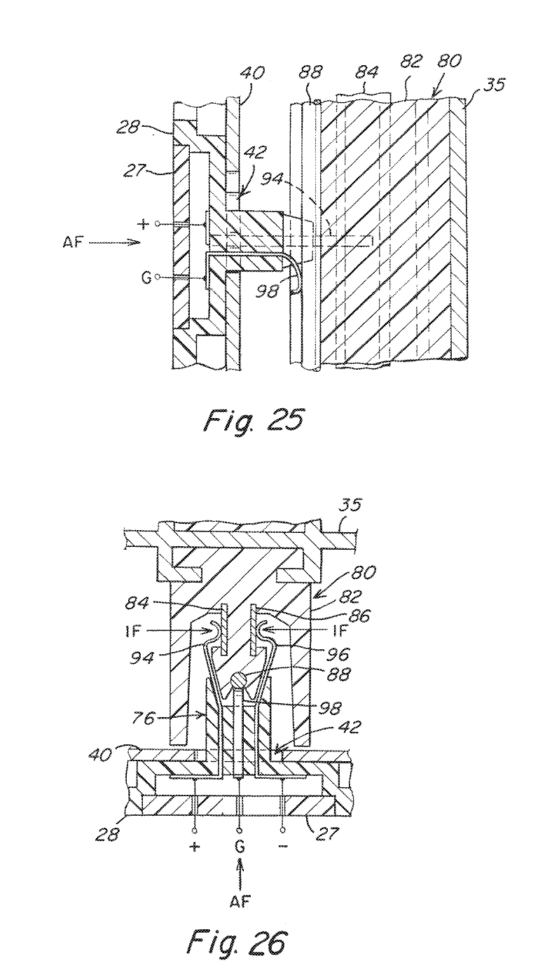

Another alternative embodiment is shown in FIGS. 21-26 where the ground contact 98 of the electrically powered device 20 is configured as an elongated member that engages the corresponding ground contact 88 of the power delivery member 80 under a spring force AF exerted as a result of a bending of the member prior to the positive 94 and negative 96 device contacts engaging their corresponding power delivery contacts 84, 86 under a radially inwardly directed spring force IF as shown. Mounting and movement of the FIGS. 21-26 assembly is the same as described above with reference to FIGS. 8-13.

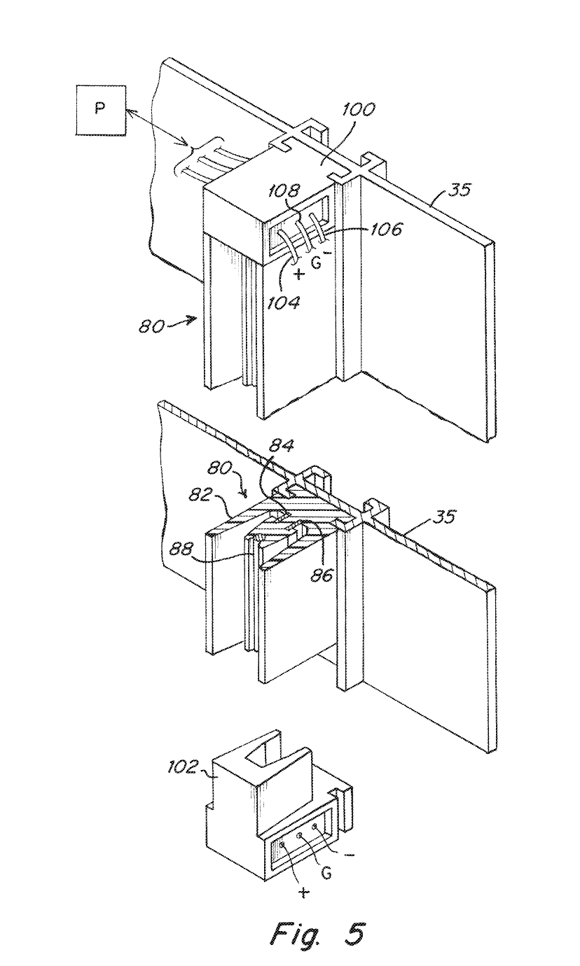

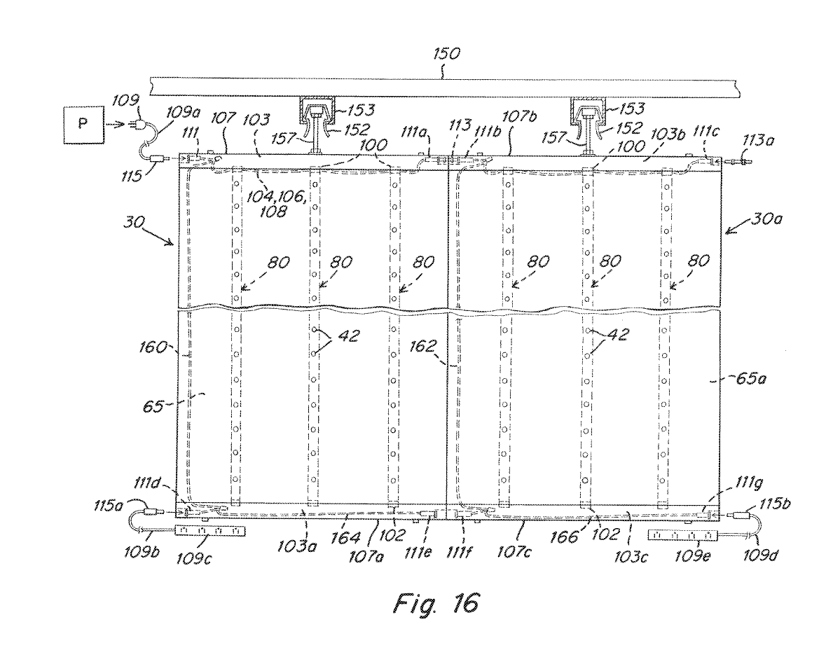

As shown in FIGS. 5, 29-32 the delivery contacts 84, 86, 88 are electrically interconnected to an original source of electrical power P, via positive, negative and ground 104, 106, 108 connecting wires that interconnect in series successively to electrical circuit splitters 100. The electrical circuit splitters 100 are typically fittingly mounted at the top terminal end of a power delivery support 82 and contain a circuit splitter device that conductively connects the wires 104, 106, 108 into conductive engagement with corresponding positive, negative and ground contacts 84, 86, 88 of each power delivery member 80 that is mounted within the housing 30. As shown, FIG. 16, successive splitters are interconnected in series by conductive wires 104, 106, 108 which at their terminal end are mounted in a plug 109 that interconnects to the original source of power P. The original source of power P supplies electrical power to all of the power delivery members 80 interconnected to each other within a single housing 30 or between separate housings where the separate housings are electrically interconnected to each other, the power being split and distributed to each power delivery member 80 via the series interconnected splitters 100. Electrical circuit splitters 102 are typically fittingly mounted at the bottom terminal end of the power delivery supports to insulate the delivery contacts 84, 86, 88 from enclosure 107a. They may or may not be connected to wires such as 104, 106,108 to connect to further circuits such as seen in FIG. 16.

As shown in FIG. 1, separate housings 12, 14, comprised of the same power delivery supports 80 and electrical connections as housing 30, can be mounted on or to housing 30 via the same pins 75, 76 and contacts 84/94, 86/96, 88/98 interconnections and engagements as described above regarding mounting of the electrically powered devices and support members 20,28 in order to provide electrical power to all of the power delivery members that are mounted within the additional separate housings 12, 14. In addition the housings 12, 14 are mountable in a stable position on the surface of wall 40 or 50 of the main housing 30 as shown in FIG. 1. As shown, once the separate housings/panels 12, 14 are fully mounted, they are independently capable of mounting and providing electrical power to electrically powered devices 24, 26 that are mounted on their walls in the same manner as described above with reference to the mounting of devices 20 on wall 40. In such an embodiment, a set of pins 75 and/or 76 are attached and arranged on or to a side wall 13, 15 of the panels 12, 14 such that the generally planar mounting walls 17, 19 of the panels 12, 14 can be mounted at a generally right angle (i.e. 90 degrees), to the generally planar wall 40 of the main panel. As shown, the mounting walls 17, 19 of the separate housings 12, 14 have an arrangement of mounting apertures 42 having the same design configuration as apertures 42 described above regarding housing 30. Thus, in such an embodiment, multiple wall surfaces 17, 19, 40 are provided in a single interconnected apparatus that is powered by a single source of power P for mounting and powering multiple devices 20, 22, 24 and 26.

In the embodiments shown in FIGS. 1-9, 10-11, 12-13, the apparatus comprises a housing structure that is comprised of a pair of opposing walls 40, 50 each having mounting apertures 42 disposed therein and each having a corresponding series of power delivery members 80 aligned with the apertures 42. As shown, FIG. 3, the housing 30 is formed by the mounting of the end walls 40, 50 to a side connector 36 which is in turn mounted to a center support 35 which in turn mounts the power delivery members 80 in an arrangement aligned with the apertures 42. In the embodiment shown, the power delivery members are elongated members mounted in a generally top-to-bottom arrangement that is complementary to the top-to-bottom arrangement of the apertures 42. In this FIGS. 1-9 housing 30 embodiment, the apparatus is modular, enabling installation and removal of a pre-selected number of power delivery members 80 by sliding insertion-mounting and removal of a support 82 onto or from the center housing support 35. Such a housing design further readily enables a single housing 30 to have two opposing spaced walls 40, 50 forming a single housing that are both capable of mounting and powering electrically powered devices on opposing sides of the housing 30.

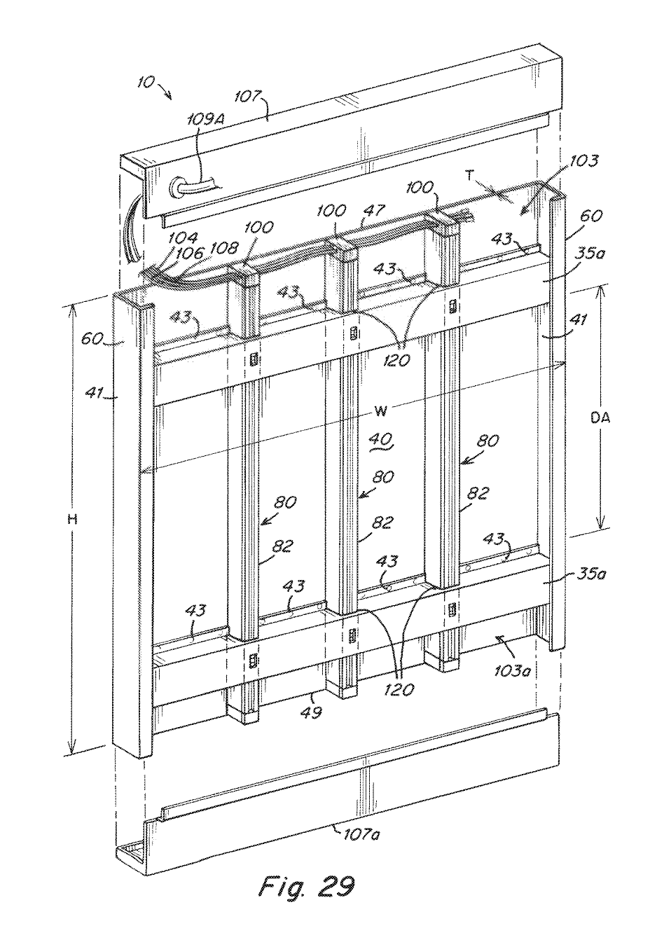

In the embodiment shown in FIGS. 27-30, 8a, 9a, 10a, 11a, 12a, 13a, the housing 30 comprises a generally planar wall 40 having top 47 and bottom 49 ends and side walls 60 that are preferably unitary with the wall 40, typically formed from a single sheet of sheet metal. As shown, the side walls 60 comprise and are formed as a flange or flanged sidewall 41 structure that is either unitary with the generally planar mounting wall 40, FIGS. 27-30, or alternatively comprises a separate structure (not shown) that is rigidly attached to the front wall 40 by welding or bolting or the like. In a preferred embodiment, the housing 30 includes reinforcing struts or beams 35a that are attached to the rear surface and extend substantially the entire width W of the wall 40, FIG. 29. Such struts or beams 35a typically comprise a structurally rigid material such as wood, solid plastic or a metal material and are typically firmly attached to the rear of the wall at multiple points 43 along or across the width W of the rear side of the wall 40. Such struts or beams 35a are configured as elongated beams or rods and are arranged such that a surface of the rigid strut or beam 35a engages against the rear surface of the wall 40 along or across substantially the entire width W of the wall.

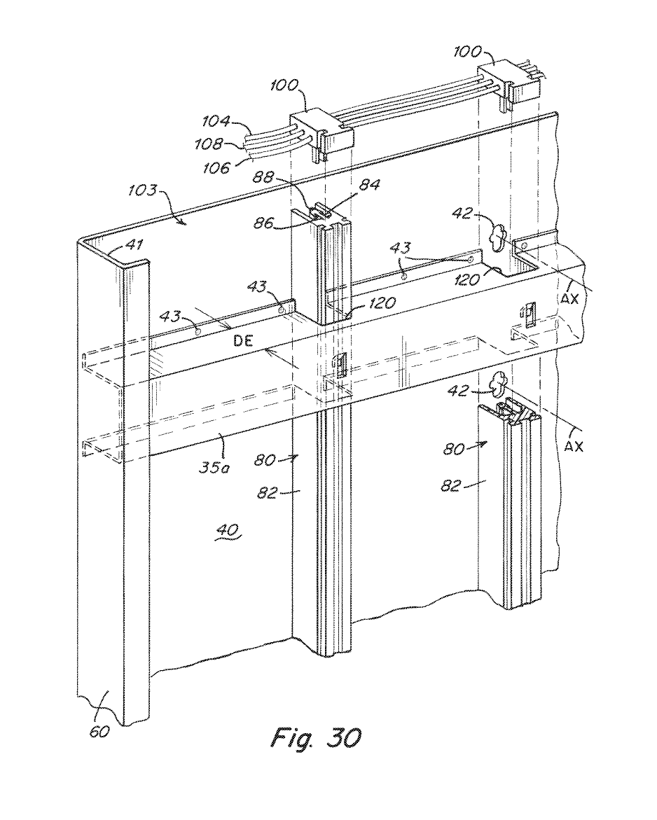

As shown the power delivery members 80 typically comprise a substantially straight elongated beam of non-conductive material 82 that extends substantially the entire vertical height H, FIG. 29, of the wall 40 from its top 47 to bottom 49 ends, the top ends of the beams or supports 82 being adapted to receive a circuit splitter 100 that connects the power P to the power delivery contacts 84, 86, 88 mounted on the supports 82. The reinforcement struts 35a are disposed at typically two or more locations along the vertical height H of the wall 40. Most preferably the beam or strut is a structurally rigid elongated beam 35a that can be formed as a hollow rectangular tube or tubular structure having a depth DE that extends through substantially the entire depth DE, FIG. 30, of the housing 30 from front to back. Alternatively the strut 35a can be configured as a solid beam typically comprised of a metal material that can be readily welded or attached to the wall 40 which itself is typically comprised of a metal material. Attachment to the rear surface of the wall 40 of two or more struts 35a at different positions along/across the height H of the wall 40 and attachment at multiple points 43 along/across the generally horizontal width W of the wall 40 imparts a rigidity to the mounting wall 40 across the horizontal width W that acts against the vertically downward force/weight of the electrically powered devices and to the housing 30 generally that enables high weight loads to be mounted on the front surface of the mounting wall 40, typically in excess of about 5 pounds, preferably in excess of about 10 pounds and most preferably in excess of about 15 pounds.

The wall 40 is typically formed of sheet metal (steel) having a thickness T, FIGS. 3, 29 of between about 0.04 and about 0.08 inches. The panel 10 preferably includes a minimum number of struts or beams 35a positioned from top 47 to bottom along the height H of the wall 40 as will accommodate or fit along or within height H such that the maximum distance DA between the closest attachment points 43 between successive or adjacent struts 35a is about 16 inches and preferably about 18 inches, i.e. the maximum distance DA between adjacent strut attachment points 43 can vary between 0 and 16 inches where the wall thickness T is between about 0.04 and 0.08. The greater the thickness T of the wall, the greater the maximum distance DA can be.

In the embodiments shown in FIGS. 27-30, the struts or beams 35a preferably include recesses or apertures or other means 120 for receiving and mounting the power delivery members 80 and their supports 82 in an arrangement complementary to and in axial alignment with the arrangement, location and mounting axes AX of the wall apertures 42, FIG. 30. Further in a preferred embodiment, FIGS. 29-30, the electrical wiring 104, 106, 108 and distribution and splitter components 100 of the system are enclosed within a predefined space 103 at the top end of the wall 40 by an enclosure 107 that is attached to the wall 40 and an adjacent strut 35a in a manner so as to obstruct manual access to the wires and splitters. Such an enclosure 107 is preferably readily attachable to and detachable from the housing 30, wall 40 or other components surrounding and around the space 103.

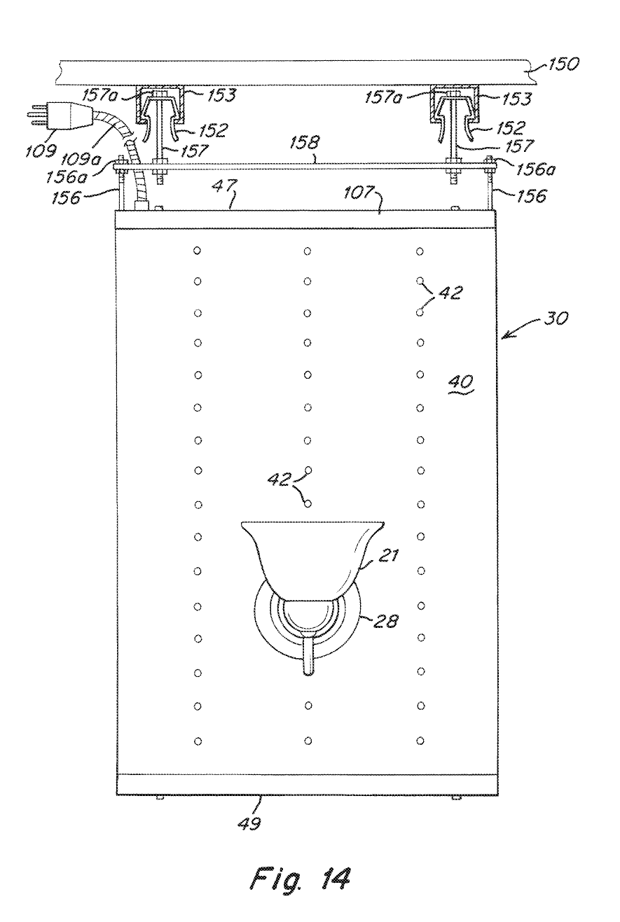

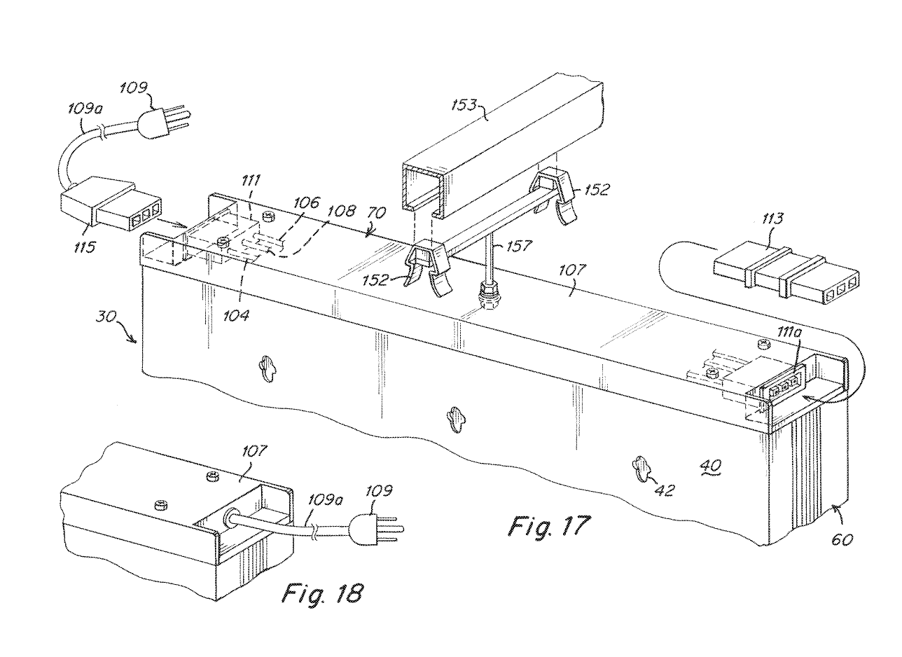

As shown in FIGS. 14-18 a panel 30 can be mounted by suspension from an overhead support 150 in a generally vertical disposition. Most preferably the mechanism by which the panel 30 is connected to the support is via quick couple and quick release mechanism such as a spring-loaded clip 152 that can be readily manually engaged/inserted into or with a complementary receiving aperture or slot provided in/on a channel member 153 connected to the overhead support 150. In the embodiment shown, the spring-loaded clip 152 is attached to and extends from the top end 47 of the panel 30 via bolts 156,157, nuts 156a, 157a and interconnecting bar 158. The overhead support 150 is connected by conventional means to a structural support on the ceiling of a room (not shown) or a wall or other like structure. Alternatively, the quick release mechanism such as spring loaded clip 152 can be connected to the overhead support 150 and the complementary receiving slot or aperture provided in a strut or channel that is connected to the top end of the housing 30. As shown, the top end 47 of the housing 30 is provided with the enclosed channel or space 103, enclosed by enclosure 107 through which live wires 104, 106 and ground wire 108 are routed along the width W of the housing via the splitters 100 mounted at the top ends of the support members 82 of the power delivery members 80. The wires routed through the space 103 can be continued in their routing out of the enclosed space 103 through a shielded cable or tube 109a that typically terminates in an electrical connection plug 109 that inputs power from a source P as seen in FIGS. 14 and 18. Alternatively as seen in FIGS. 16 and 17 the live wires 104, 106 and ground wire 108 can routed through the enclosed space 103 and connected to power source P via modular connector 111 and connector 115 to cable 109a and plug 109 at one end and can be terminated at connector 111a at the other end. Connector 111a can be accessed by a modular connector such as 113, 113a or a connector such as 115a or 115b such that electrical power from the same source P that is input to and powers the power delivery members 80 can be further conveniently and safely routed or connected via the outlet 111a to or from another device/apparatus that requires electrical power.

As shown in FIG. 16 two separate panels 30, 30a are mounted adjacent to each other from an overhead support 150 and are electrically interconnected to each other via modular connector 113 that interconnects modular outlet connectors 111a, 111b such that the single source of power P that is input to panel 30 by way of power plug 109, cable 109a and modular connector 115 is routed via connectors 111a, 111b, 113 to provide power to panel 30a. And the same electrical power is routed through channel 103b in enclosure 107b to another connector 111c which in turn can be interconnected to modular connector 113a which can be interconnected to a further panel or panels 30. Alternatively the connector 111a may be interconnected to a connector 115a or 115b to connect to another electrically powered device and thus deliver electrical power from the same original source P. As can be readily imagined, the separate panels 30, 30a can alternatively be mounted in any manner on a ground surface, on a wall or the like and the serial connections as described can still be made between the panels 30, 30a.

Further as shown in FIG. 16, a panel according to the invention can include electrical circuit power splitting mechanisms that split electrical power from the wires 104, 106, 108 in the top channels 103, 103b and route the split power through a bundle of corresponding wires 160, 162 through the interior spaces 65, 65a of the housings 30, 30a to any other desired portion of the housings 30, 30a such as to channels 103a, 103c along the bottom of the panels. Such bottom channels/spaces 103a, 103c are preferably enclosed by an enclosure 107a, 107c respectively to prevent manual access to the live wire bundles 164, 166 resident in spaces 103a, 103c that are split from the downwardly routed wire bundles 160, 162. As shown, the wire bundles 164, 166 are interconnected to connector outlets 109c, 109e (depicted for purposes of example only as multi-modular electrical outlets) via cables 109b, 109d that are interconnected to modular connectors 115a, 115b which are in turn connected to modular connectors 111d, 111g. As shown the split wire bundles 160, 162 routed to the bottom of the panels 30, 30a are also split again to connect to modular connectors 111d, 111e, 111f and 111g which are available to the user of the system to connect another electrically powered device to in a convenient location. By virtue of the splitting of the wires 104, 106, 108 and bundles 160, 162, 164, 166 to all of the various connectors/outlets, the entire system is supplied with electrical power by the single source P which is connected to the system via the one modular connector 111. Alternatively the circuit splitters 102 at the bottom of the power delivery members 80 may be wired to the modular connectors 111d-111g instead of using wire bundles 162-166. In the FIGS. 16-18 embodiment, the top surface of the enclosure 107 also serves as the top wall 70 of the housings 30, 30a.

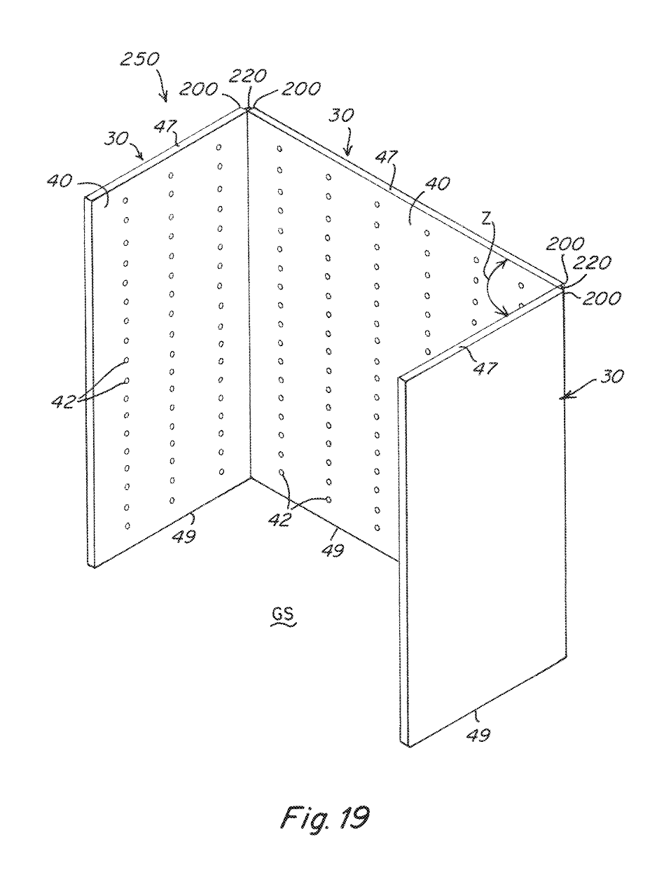

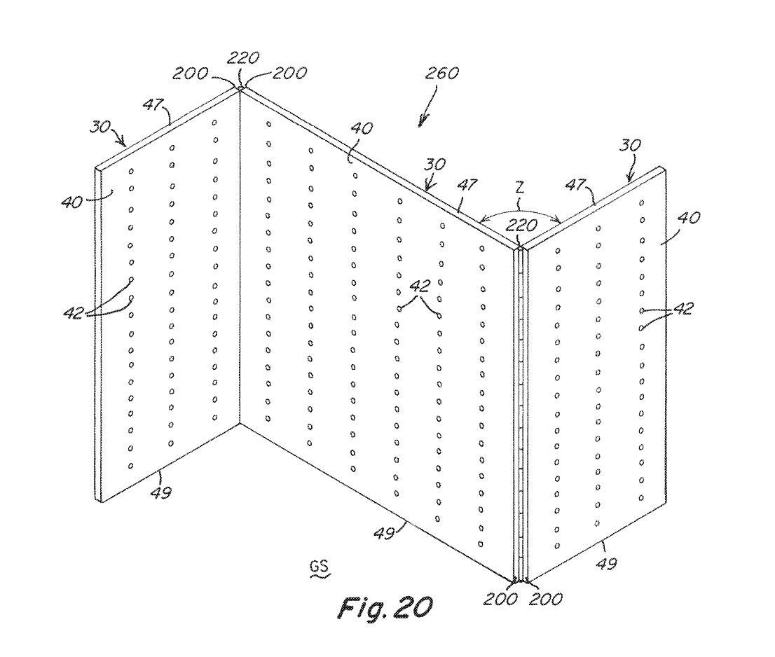

In typical embodiments of the invention, the geometry of the front and back faces of the panels 30, 30a are such that the bottom ends 49 are straight and the sides of the panels are generally straight and perpendicular to the bottom edge 49 such that the edges can be readily mechanically attached to each other at an angle by a mechanism such as a hinge. As shown in FIGS. 19 and 20 two or more panels 30 can are mechanically connected at their side edges 200 such that their wall surfaces 40 are disposed at either an acute, right or obtuse angle Z to each other. The structural rigidity of the individual housings 30 together with their angled connection 220 at an angle Z of typically between about 10 and about 170 degrees, preferably between about 20 and about 160 degrees, more preferably between about 25 and about 155 degrees, enables the connected panels 30 to be mounted on their bottom ends 49 on a ground surface GS in a stable, self-supporting vertically upright disposition without the necessity of the use of other mounting means to maintain the assemblies in the vertically upright positions shown although other mechanisms such as pads, feet, props or the like may be additionally attached to the bottom or front or back sides of the panels to engage the ground surface and further stabilize the generally vertically upright positioning of the assemblies 250, 260. In such assemblies, the bottom ends 49 of the panels 30 connected at selected angle Z cooperate with each other in their angled arrangement to provide opposing forces in opposite directions that balance the position of the assemblies 250, 260 against inertia or other forces such as gravity that would otherwise cause the assemblies 250, 260 to move or fall over from their vertically upright dispositions as shown. As can be readily imagined the variety of angles Z and the number and variety of assembled panels is widely variable.

1. A method of mounting an electrically powered device having power receiving contacts and a ground contact on a display comprising a mounting wall having a front surface and a rear surface, the method comprising:
mounting one or more power delivery members having power delivery contacts and a ground contact on the rear surface of the mounting wall in a select arrangement;
forming a series of apertures in the mounting wall that are adapted to receive the power receiving and ground contact of the electrically powered device,
housing the power receiving and ground contact of the electrically powered device in a housing that prevents electrically conductive manual engagement or contact with the power receiving and ground contact of the electrically powered device,
adapting the electrically powered device to be mounted on the front surface of the mounting wall via insertion of the housed power receiving and ground contact of the electrically powered device through one of the series of apertures in the mounting wall;
the power delivery and ground contacts of the power delivery members being arranged such that when the electrically powered device is mounted on the front surface of the mounting wall, the ground contact of the power delivery member engages with a complementary mating contact of the electrically powered device before the power delivery contacts of the power delivery member engage with a complementary power receiving contact of the electrically powered device during the course of the electrically powered device being mounted on the front side of the mounting wall, and,
inserting the housed power receiving and ground contact of the electrically powered device through one of the series of apertures in the mounting wall.

2. The method of claim 1 further comprising arranging the power delivery members on the rear surface of the mounting wall and adapting the series of apertures in the mounting wall such that manual engagement or contact with the power delivery contacts through an aperture from a position on the front surface of the mounting wall is prevented.

3. A method of mounting an electrically powered device having power receiving contacts for mounting and powering of the device on a display housing having a mounting wall having a front surface and a rear surface, the method comprising:
housing the power receiving contacts in a mounting pin projecting from the electrically powered device, the power receiving contacts being protected against electrically conductive manual engagement or contact by the mounting pin;
mounting one or more power delivery members having power delivery contacts on the rear surface of the mounting wall in a select arrangement;
forming a series of apertures in the mounting wall that are adapted to receive and retain the mounting pin of the electrically powered device upon receipt;
arranging the formed apertures on the mounting wall of the housing in an arrangement that is complementary to the select arrangement of the power delivery members mounted on the rear surface such that the mating contacts of the electrically powered device are guided or routed into engagement with the power delivery contacts upon receipt of the pin through a primary aperture formed in the wall; and,
inserting the pin of the electrically powered device into one of the apertures and guiding the mating contacts into engagement with the power delivery contacts during the inserting of the pin.

4. The method of claim 3 further comprising:
providing the power delivery member with a ground contact; and,
guiding a corresponding ground mating contact of the electrically powered device into engagement with the ground contact of the power delivery member prior to guiding the other mating contacts into engagement with the power delivery contacts during the inserting.

5. The method of claim 3 further comprising forming the apertures into a configuration that prevents lateral or axial movement of the pin out of the apertures on receipt of the pin within an aperture.

6. An electrical power distribution and mounting system, the system comprising:
a housing comprising a mounting wall having a front side, a rear side and a plurality of apertures arranged in a select pattern,
a power delivery member mounted on the rear side of the mounting wall, the power delivery member including power delivery contacts and a ground contact aligned with the plurality of apertures in the mounting wall and arranged on the power delivery member in a select arrangement for electrically powering one or more electrically powered devices,
each electrically powered device including complementary mating contacts projecting from the electrically powered device in an arrangement that is complementary to the select arrangement of the power delivery and ground contacts of the power delivery member,
each electrically powered device being mountable in a stable position on the front side of the mounting wall such that the mating contacts projecting from the electrically powered device extend through one of the apertures in the mounting wall and engage with a corresponding power delivery contact and ground contact of the power delivery member when or as the electrically powered device is fully mounted in the stable position, the mating contacts projecting from the electrically powered device being housed or covered against electrically conductive contact or engagement with a hand or external object, and,
wherein the select arrangement of the power delivery contacts and the ground contact of the electrical power delivery member is selected such that the ground contact of the power delivery member engages with a complementary mating contact of the electrically powered device before the power delivery contacts of the power delivery member engage with a complementary mating contact of the electrically powered device during the course of the electrically powered device being mounted on the front side of the mounting wall.

7. The system of claim 6 wherein the power delivery members are mounted on the rear side of the mounting wall and the power delivery contacts and the ground contact are all arranged such that manual engagement with the power delivery contacts through an aperture from a position from the front side of the mounting wall is prevented.

8. The system of claim 6 wherein the electrically powered device has a base having at least one mounting pin protruding from the base in a pattern complementary to the select pattern of the apertures in the mounting wall,
the at least one pin housing the mating contacts projecting from the electrically powered device and supporting the weight of the electrically powered device on the mounting wall,
the mating contacts being arranged on the electrically powered device and the electrical power delivery contacts being arranged on the rear side of the mounting wall for electrically conductive engagement between the matting contacts and the power delivery and ground contacts during the course of insertion of the mounting pins through the two apertures.

9. The system of claim 6 including at least one mounting pin comprised of a shaft and a head connected to the end of the shaft, the shaft and the head having selected configurations, the apertures in the mounting wall having a first portion complementary to the head configuration for receiving the head and a second portion complementary to the shaft configuration for receiving the shaft; and,
the head of the at least one pin forming an interference fit against the second portion of the primary aperture to mount the base of the electrically powered device on the mounting wall.

10. The system of claim 6 wherein the pins and the respective apertures in which the the pins are received are adapted to receive and retain the pins against lateral or axial movement out of the respective apertures.

11. A method of mounting an electrically powered device in an electrical power distribution system as claimed in claim 6 comprising extending the mating contacts projecting from the electrically powered device through one of the apertures in the mounting wall and engaging the mating contacts with a corresponding power delivery contact and ground contact of the power delivery member of the system of claim 6.

12. An electrical power distribution and mounting system, the system comprising:
a housing comprising a mounting wall having a front side, a rear side and a plurality of apertures arranged in a select pattern,
a power delivery member mounted on the rear side of the mounting wall, the power delivery member including power delivery contacts and a ground contact aligned with the plurality of apertures in the mounting wall and arranged on the power delivery member in a select arrangement for electrically powering one or more electrically powered devices,
each electrically powered device including complementary mating contacts housed within a pin projecting from and supporting the weight of the electrically powered device on the front side of the mounting wall, the complementary mating contacts being arranged in an arrangement that is complementary to the select arrangement of the power delivery and ground contacts of the power delivery member,
each electrically powered device being mountable in a stable position on the front side of the mounting wall such that the pin with the mating contacts projecting from the electrically powered device extend through one of the apertures in the mounting wall, the mating contacts engaging with a corresponding power delivery contact and ground contact of the power delivery member when or as the electrically powered device is fully mounted in the stable position,
wherein the select arrangement of the power delivery contacts and the ground contact of the electrical power delivery member is selected such that the ground contact of the power delivery member engages with a complementary mating contact of the electrically powered device before the power delivery contacts of the power delivery member engage with a complementary mating contact of the electrically powered device during the course of the electrically powered device being mounted on the front side of the mounting wall.

13. The system of claim 12 wherein the pin houses or covers the mating contacts of the electrically powered device against electrically conductive contact or engagement with a hand or external object.
